(19) United States
(12) Patent Application Publication
(10) Pub. No.: US 2026/0143244 A1
(43) Pub. Date: May 21, 2026

(54) METHOD AND SYSTEM FOR GENERATING ENHANCED REPRESENTATIONS OF A SUBJECT FOR VIDEO-BASED MARKERLESS MOTION CAPTURE

(71) Applicant: Theia Markerless, Inc., Kingston (CA)

(72) Inventors: Marcus BROWN, Kingston (CA); Chris SALIBA, Hinton (CA); Pete LOAN, Chicago, IL (US)

(73) Assignee: Theia Markerless, Inc., Kingston (CA)

(21) Appl. No.: 18/950,989

(22) Filed: Nov. 18, 2024

(51) Int. Cl. H04N 23/90

(52) U.S. Cl. CPC H04N 23/90

(57) ABSTRACT

A method and apparatus for supporting motion capture systems, such as markerless systems, is provided. Initial representations, such as salient points, of a physical subject are received based on camera data. Enhanced representations, such as improved salient points or vector indications, of a physical subject are then identified based on the initial representations in combination with specified physical constraints. A model can be used to specify the physical constraints, and the enhanced representations can be obtained as locations or other features of the model. The enhanced representations are thus inherently constrained by the model. The enhanced representations can be used for AI training or for other purposes.

### FIELD OF THE INVENTION

The present invention pertains to the field of motion capture systems by which data such as animation data is created from object motions observed via camera, and in particular to machine learning supported motion capture systems.

### BACKGROUND

Motion capture systems are used extensively to record and abstract the movements of objects, most commonly humans but potentially also animals or other moving objects such as vehicles. In a common scenario, human subjects (e.g. actors or others) wearing a motion capture suit are recorded, and the recorded information, transformed into appropriate digital data, is used to animate digital character models in an animation. Motion capture is used in entertainment, robotics, kinesiology, and medical/clinical and scientific research, for example.

Machine learning and artificial intelligence (AI) have been developed to interoperate with motion capture systems. Another example is markerless motion capture, which does not necessarily require specialized wearables, suits or markers. Markerless motion capture systems have been proposed in which a trained AI system is leveraged to identify virtual markers on images of a human subject, reducing the need for physical markers placed on the subject, or the use of a motion capture suit.

However, training of AI systems is a highly involved process, and even extensively trained AI systems can be inaccurate or produce unexpected and undesired artefacts. The current state of the art in the area of both motion capture and supporting AI, is subject to improvement.

Therefore, there is a need for a motion capture system and associated machine learning and AI systems and supports, that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide methods of generating motion capture systems which use artificial intelligence, training of such artificial intelligence, the generating of corresponding training data, and the resulting motion capture systems.

According to embodiments of the present invention, a method and apparatus for supporting motion capture systems, such as markerless systems, is provided. Enhanced representations of markers (such as salient points, vectors, rigid bodies, etc.) are identified on or associated with a model of a physical subject. The model may be, for example, a skeleton model (anatomically) representative of a human or an animal, that incorporates physical constraints for the physical subject. The model can be configured to match dimensions and position, orientation and/or pose of a subject as it appears in camera images, or as determined via other measurements. The enhanced representations are then used to generate enhanced training data for training of an enhanced artificial intelligence (AI) module. The enhanced AI module, so trained on data that is based on enhanced representations derived from the model, will output inherently constrained representations of a physical subject, for example as depicted in a received video feed or one or more image frames that include the physical subject obtained, although not necessarily, using a single camera. Generating the enhanced training data can involve backprojecting the enhanced representations from three-dimensional model space onto two-dimensional planes representing or being camera images.

Because the AI module is trained on the output of a model, the constraints of the model (e.g. a posable skeleton in three dimensional space) will become inherent to the AI module. The AI module can thus be desirably constrained, e.g. so that various physical laws are followed, physical features of the physical subject are consistent over time, and the like.

According to an aspect of the present invention, there is provided a computing apparatus for supporting training of an enhanced artificial intelligence (AI) module for video-based motion or still image capture, the apparatus comprising one or more processing modules configured to: obtain one or more enhanced representations of a physical subject generated based on a model of the physical subject, the model generated based at least in part on one or more training camera image frame sets or other input indicative of the physical subject, the one or more enhanced representations of the physical subject corresponding to one or more physical locations on, or more generally physical features of, the physical subject and being constrained according to the model; and provide enhanced training data for training of the enhanced AI module to output data for the physical subject or another physical subject following the training, the output data being inherently constrained due to the model, the enhanced training data including the one or more enhanced representations of the physical subject.

In various embodiments, the one or more enhanced representations of the physical subject includes one or more of: one or more enhanced representations of salient points for the physical subject; one or more enhanced vector representations for the physical subject; one or more enhanced representations position, orientation, or both, of the physical subject in the one or more training camera image frame sets; and one or more enhanced pose representations of a pose of the physical subject in the one or more training camera image frame sets.

In various embodiments, obtaining the one or more enhanced representations of the physical subject comprises one or both of: generating the model; and generating the one or more enhanced representations of the physical subject based on the model.

In various embodiments, the model is generated based at least in part on physical constraints for the physical subject in combination with the one or more training camera image frame sets indicative of the physical subject, the model being generated to match with a position, orientation, or both, of the physical subject as appearing in the one or more training camera image frame sets.

In various embodiments, the model is further generated based on one or more initial representations of the physical subject generated using the one or more training camera image frame sets.

In various embodiments, the one or more initial representations of the physical subject includes one or more of: one or more initial representations of salient points for the physical subject; one or more initial vector representations for the physical subject; one or more initial representations of a position, orientation, or both, of the physical subject in the one or more training camera image frame sets; and one or more initial pose representations of a pose of the physical subject in the one or more training camera image frame sets. In this context, the one or more initial representations of position, orientation, or both, and/or the one or more initial pose representations are (e.g., physically, in terms of physical constraints) unconstrained and generated using one or more of: the one or more initial representations of salient points; and the one or more initial vector representations.

In various embodiments, the model is: an articulated model including two or more rigid bodies interconnected with one another at one or more flexible joints movable within a limited or unlimited range; a model having two or more parts movable relative to one another; a model having one or more flexible surfaces; or a model of a single movable rigid body.

In various embodiments, generating the articulated model to match with the position, orientation, or both, of the physical subject comprises configuring sizes, locations and orientations of the two or more rigid bodies.

In various embodiments, at least one of the one or more enhanced representations of the physical subject is defined as being at a fixed location relative to a corresponding one of the rigid bodies.

In various embodiments, the articulated model is a skeleton model representative of a human or an animal, or the articulated model is representative of a non-living object.

In various embodiments, the one or more enhanced representations includes the one or more enhanced representations of salient points for the physical subject, the one or more enhanced representations of salient points being constrained according to the model of the physical subject, and at least one of the salient points has an anatomical meaning for the physical subject.

In various embodiments, the one or more enhanced representations includes the one or more enhanced representations of salient points for the physical subject, and providing the enhanced training data comprises, for an enhanced representation of a salient point of the one or more enhanced representations of salient points: for each camera belonging to a set of one or more real or virtual cameras, determining one or both of: a position, within an output image of the camera, at which the enhanced representation of the salient point would be indicated by the camera as if a corresponding salient point were visible to the camera, the position determined based on an angle, a field of view dimensions and a location information for the camera, the output image showing the physical subject or the model of the physical subject from a point of view of the camera; and a distance from the salient point to the camera, the distance based on at least the location information for the camera. The enhanced training data includes, for each camera belonging to the set of one or more real or virtual cameras, one or both of: the position at which the enhanced representation of the salient point would be indicated by the camera; and the distance from the salient point to the camera.

In various embodiments, providing the enhanced training data further comprises: for each camera belonging to the set of one or more real or virtual cameras: generating, based on the model and the angle, the field of view dimensions and the location information for the camera: the output image of the camera. The enhanced training data includes the output image of the camera, for each of the cameras belonging to the set of one or more real or virtual cameras.

In various embodiments, providing the enhanced training data comprises: for each camera belonging to a set of one or more real or virtual cameras: generating, based on the model and angle, field of view dimensions and location information for the camera: an output image of the camera, the output image showing the physical subject or the model of the physical subject from a point of view of the camera. The enhanced training data includes the output image of the camera, for each camera belonging to the set of one or more real or virtual cameras, and the enhanced representations are correlated with the output image, represented on the output image, or both.

In various embodiments, the output image is a corresponding training camera image frame of the one or more set of the training camera image frames.

In various embodiments, the model is an articulated model, and the physical constraints include: articulation constraints indicative of limitations to positions, orientations, or both, of the physical subject, according to the articulated model.

In various embodiments, the one or more training camera image frame sets includes multiple training camera image frame sets, each of the multiple training camera image frame sets representing at least one image of the physical subject at a different respective (nominal) instance in time; and the physical constraints include one or more of: consistency constraints indicative that one or more characteristics of the physical subject are consistent across all of the multiple training camera image frame sets; and kinematic constraints, dynamic constraints, or a combination thereof, indicating limitations to changes in position, orientation, pose, or a combination thereof, of the physical subject, as indicated by differences between different ones of the multiple training camera image frame sets.

In various embodiments, the one or more enhanced representations of the physical subject comprise one or more enhanced representations of salient points for the physical subject, the one or more enhanced representations of salient points being indicative of locations on, or physical features of, the model that correspond to the one or more physical locations on the physical subject, and the locations on the model being three-dimensional spatial coordinates.

In various embodiments, the one or more processing modules are further configured to train the enhanced AI module using the enhanced training data.

In various embodiments, the one or more processing modules include the enhanced AI module, the enhanced AI module being configured to output the motion or still image capture data following training thereof.

In various embodiments, each of the one or more training camera image frame sets includes multiple camera image frames, and each of the camera image frames of a same one of the multiple training camera image frame sets is indicative of a real or virtual camera image of the physical subject, at a same (nominal) time and from a different respective angle.

In various embodiments, the model is an articulated model, and at least one processing module of the one or more processing modules is configured to define parameters for generation of the articulated model of the physical subject based at least in part on the one or more training camera image frame sets, the one or more enhanced representations being constrained due to having been generated from the articulated model, the articulated model including two or more rigid bodies interconnected with one another at one or more flexible joints movable within a limited or unlimited range. The parameters include one or more of: sizes, locations and orientations of the two or more rigid bodies.

In various embodiments, the one or more training camera image frame sets include two or more training camera image frame sets, and the model (which may be an articulated model) is constrained in that sizes of at least some of its constituent (e.g. rigid) bodies are unchanging over all of the two or more training camera image frame sets, and wherein the locations and orientations of these constituent bodies are subject to variation between different ones of the two or more training camera image frame sets.

According to an aspect of the present invention, there is provided a method for supporting training of an enhanced artificial intelligence (AI) module for video-based motion or still image capture, the method comprising, by a computer: obtaining one or more enhanced representations of a physical subject generated based on a model of the physical subject, the model generated based at least in part on one or more training camera image frame sets or other input (e.g., photographs, real or virtual images, real or animated video, etc.) indicative of the physical subject, the one or more enhanced representations of the physical subject corresponding to one or more physical locations on, or physical features of, the physical subject and being constrained according to the model; and providing enhanced training data for training of the enhanced AI module to output data for the physical subject or another physical subject following the training, the output data being inherently constrained according to the model, the enhanced training data including the one or more enhanced representations of the physical subject. Other aspects of the method, for example commensurate with aspects of the apparatus as described above, can also be provided.

According to another aspect of the present invention, there is provided a computing apparatus for video-based motion or still image capture, the apparatus comprising: an input module configured to receive camera data comprising one or more camera image frame sets and indicative of a physical subject; a processing module configured to produce output data based on the camera data. The output data is provided at least in part using an enhanced AI module having been trained using enhanced training data that is at least in part obtained from a model of the physical subject or another physical subject, the output data being inherently constrained due to usage of the model in obtaining of the enhanced training data; and an output module configured to provide the output data.

In various embodiments, the output data is motion capture data, still image capture data, further AI module training data, measurements of the physical subject, inferences for the physical subject, or predictions for the physical subject.

In various embodiments, the camera data is obtained using one or more real or virtual cameras.

In various embodiments, the output is used in generating of one or more of: an animation of the physical subject according to at least a portion of the camera data; a three-dimensional computerized model of the physical subject; a visual overlay of the output with at least a portion of the camera data; indicator data for the physical subject, the indicator data indicative of one or more of: a speed of the physical subject between two or more camera image frames of the one or more camera image frame sets; one or both of: a distance between two salient points of the physical subject, and an angle between the two salient points of the physical subject relative to a reference point; and one or both of a distance between a salient point of the physical subject and a further salient point of a further physical subject, and an angle between the salient point of the physical subject and the further salient point of the further physical subject relative to a reference point, the one or more camera image frame sets further indicative of the further physical subject.

In various embodiments, the output data includes one or more inherently constrained representations of the physical subject.

In various embodiments, the model incorporates or is configured according to physical constraints for the physical subject or the other physical subject.

In various embodiments, the one or more inherently constrained representations of the physical subject include one or more of: one or more inherently constrained representations of salient points for the physical subject; one or more inherently constrained vector representations for the physical subject; one or more inherently constrained representations of a position, orientation, or both, of the physical subject in the one or more camera image frame sets; one or more inherently constrained pose representations of a pose of the physical subject in the one or more camera image frame sets; and an inherently constrained three-dimensional computerized representation of the physical subject.

In various embodiments, the model is provided at least in part based on the physical constraints in combination with training camera data that includes one or more training camera image frame sets indicative of the physical subject or the other physical subject, and the model is further provided to correspond with a position, orientation, or both, of the physical subject or the other physical subject as appearing in the one or more training camera image frame sets.

In various embodiments, the model is further provided based on one or more initial representations of the physical subject or the other physical subject generated using the one or more training camera image frame sets.

In various embodiments, the model is: an articulated model including two or more rigid bodies interconnected with one another at one or more flexible joints movable within a limited or unlimited range; a model having two or more parts movable relative to one another; a model having one or more flexible surfaces; or a model including a single movable rigid body.

In various embodiments, the articulated model is configured to correspond with the position, orientation, or both, of the physical subject or the other physical subject as appearing in the one or more training camera image frame sets at least in part by configuring sizes, locations and orientations of the two or more rigid bodies.

In various embodiments, the enhanced training data includes one or more enhanced representations of the physical subject or the other physical subject, and at least one of the one or more enhanced representations of the physical subject or the other physical subject is defined as being at a fixed location relative to a corresponding one of the rigid bodies.

In various embodiments, the articulated model is a skeleton model representative of a human or an animal. In various embodiments, the articulated model is representative of a non-living and/or inanimate object.

In various embodiments, the one or more inherently constrained representations of the physical subject includes the one or more inherently constrained representations of salient points for the physical subject, at least one of the one or more inherently constrained representations of salient points being representative of a respective salient point having an anatomical meaning for the physical subject.

In various embodiments, the enhanced training data includes one or more enhanced representations of the physical subject or the other physical subject, the one or more enhanced representations including one or more enhanced representations of salient points for the physical subject or the other physical subject, and an enhanced representation of a salient point of the plurality of enhanced representations of salient points is generated at least in part by: for each camera belonging to a set of one or more real or virtual cameras and configured to provide training camera data, determining one or both of: a position, within an output image of the camera, at which the enhanced representation of the salient point would be indicated by the camera as if a corresponding salient point were visible to the camera, the position determined based on an angle, a field of view dimensions and a location information for the camera; and a distance from the salient point to the camera, the distance based on at least the location information for the camera. The enhanced training data includes, for each camera of the set of one or more real or virtual cameras, one or both of: the position at which the enhanced representation of the salient point would be indicated by the camera; and the distance from the corresponding salient point to the camera.

In various embodiments, the enhanced training data further comprises: for each camera of the set of one or more real or virtual cameras: the one or more enhanced representations of salient points; and the output image showing the physical subject or the model from a point of view of the camera.

In various embodiments, the enhanced training data comprises: for each camera belonging to a set of one or more real or virtual cameras: an output image of the camera, the output image showing the physical subject or the model of the physical subject from a point of view of the camera. The output image of the camera is generated based on the model and angle, field of view dimensions and location information for the camera.

In various embodiments, the output image is a corresponding training camera image frame of the one or more set of the training camera image frames.

In various embodiments, the one or more training camera image frame sets are used in generating the model of the physical subject or the other physical subject.

In various embodiments, the enhanced training data comprises: a plurality of images of: the physical subject or the other physical subject from one or more image frame sets obtained using the set of one or more real or virtual cameras configured to provide training camera data; or the model of the physical subject or the other physical subject; and a plurality of enhanced representations of the physical subject or the other physical subject the plurality of enhanced representations comprising one or more of: one or more enhanced representations of salient points for the physical subject or the other physical subject in corresponding one or more images of the plurality of images; one or more enhanced vector representations for the physical subject or the other physical subject in corresponding one or more images of the plurality of images; one or more enhanced representations of a position, orientation, or both, of the physical subject or the other physical subject in corresponding one or more images of the plurality of images; and one or more enhanced pose representations of a pose of the physical subject or the other physical subject in corresponding one or more images of the plurality of images.

In various embodiments, the model is an articulated model, and the physical constraints include: articulation constraints indicative of limitations to positions, orientations, or both, of the physical subject or the other physical subject, according to the articulated model.

In various embodiments, the training camera data includes multiple image frame sets, each of the multiple image frame sets representing at least one image of the physical subject or the other physical subject at a different respective (nominal) instance in time; and the physical constraints include one or more of: consistency constraints indicative that one or more characteristics of the physical subject are consistent across all of the multiple image frame sets; and kinematic constraints, dynamic constraints, or a combination thereof, indicating limitations to changes in position, orientation, pose, or a combination thereof, of the example physical subject, as indicated by differences between different ones of the multiple image frame sets.

In various embodiments, the enhanced training data comprises one or more enhanced representations of salient points for the physical subject of the other physical subject, the one or more enhanced representations of salient points being indicative of locations on the model that correspond to one or more physical locations on, or physical features of, the physical subject or the other physical subject, the locations on the model being three-dimensional spatial coordinates.

In various embodiments, the model is generated at least in part based on training camera data that includes one or more training camera image frame sets indicative of the physical subject or the other physical subject, each of the one or more training camera image frame sets including multiple camera image frames. Each of the camera image frames of a same one of the training camera image frame sets is indicative of a real or virtual camera image of the physical subject or the other physical subject, at a same (nominal) time and from a different respective angle.

In various embodiments, the model is an articulated model; the processing module or another processing module is configured to define parameters for generation of the articulated model based at least in part on training camera data that includes one or more training camera image frame sets indicative of the physical subject or the other physical subject; the training data comprises one or more enhanced representations of the physical subject or the other physical subject, the one or more enhanced representations being constrained due to having been generated from the articulated model; and the articulated model includes two or more rigid bodies interconnected with one another at one or more flexible joints movable within a limited or unlimited range. The parameters include one or more of: sizes, locations and orientations of the two or more rigid bodies.

In various embodiments, the one or more training camera image frame sets include two or more training camera image frame sets, and the (e.g. articulated) model is constrained in that sizes of some or all of the model's constituent rigid bodies are unchanging over all of the two or more training camera image frame sets. The locations and orientations of the constituent rigid bodies are subject to variation between different ones of the two or more training camera image frame sets.

According to an aspect of the present invention, there is provided a method for video-based motion or still image capture, the method comprising, by a computer: receiving camera data comprising one or more camera image frame sets and indicative of a physical subject; and providing output data based on the camera data. The output data is provided at least in part using an enhanced AI module having been trained using enhanced training data that is at least in part obtained from a model of the physical subject or another physical subject, the output data being inherently constrained due to usage of the model in obtaining of the enhanced training data. Other aspects of the method, for example commensurate with aspects of the apparatus as described above, can also be provided.

According to an aspect of the present invention, there is provided a computing apparatus for supporting video-based motion or still image capture, the apparatus comprising one or more processing modules configured to: receive one or more initial representations of a physical subject, the one or more initial representations provided based on camera data including one or more camera image frame sets; provide, based on the one or more initial representations of the physical subject in combination with physical constraints specified for the physical subject, one or more enhanced representations of the physical subject, each of the one or more enhanced representations of the physical subject being constrained according to a model of the physical subject, the model incorporating or being configured according to the physical constraints; and provide output data which includes or is based at least in part on the one or more enhanced representations of the physical subject.

In various embodiments, the one or more initial representations of the physical subject include one or more of: one or more initial representations of salient points for the physical subject; one or more initial vector representations for the physical subject; one or more initial representations of a position, orientation, or both, of the physical subject in the one or more training camera image frame sets; and one or more initial pose representations of a pose of the physical subject in the one or more image frame sets. The one or more initial representations of position, orientation, or both, and/or the one or more initial pose representations are (e.g., physically, in terms of physical constraints) unconstrained and generated using one or more of: the one or more initial representations of salient points; and the one or more initial vector representations.

In various embodiments, the one or more enhanced representations of the physical subject include one or more of: one or more enhanced representations of salient points for the physical subject; one or more enhanced vector representations for the physical subject; one or more enhanced representations of a position, orientation, or both, of the physical subject or the other physical subject in corresponding one or more images of the plurality of images; and one or more enhanced pose representations of a pose of the physical subject in the one or more camera image frame sets.

In various embodiments, the one or more camera image frame sets includes multiple camera image frame sets, each of the multiple camera image frame sets includes multiple image frames. Each of the image frames of a same one of the image frame sets is indicative of a real or virtual camera image of the physical subject, at a same (nominal) time and from a different respective angle.

In various embodiments, the apparatus further comprises another processing module configured to provide the one or more initial representations of the physical subject.

In various embodiments, the model is an articulated model, and the physical constraints include: articulation constraints indicative of limitations to positions, orientations, or both, of the physical subject, according to the articulated model for the physical subject, in each of the one or more camera image frame sets taken individually or in combination.

In various embodiments, the one or more camera image frame sets includes multiple camera image frame sets, each of the multiple camera image frame sets representing a different respective (nominal) instance in time; and the physical constraints include one or more of: consistency constraints indicative that one or more characteristics of the physical subject are consistent across all of the multiple image frame sets; and kinematic constraints, dynamic constraints, or a combination thereof, indicating limitations to changes in position, orientation, pose, or a combination thereof, of the physical subject, as indicated by differences between different ones of the multiple camera image frame sets.

In various embodiments, the model is an articulated model, and the one or more processing modules are configured to define parameters of the articulated model of the physical subject based at least in part on the one or more initial representations of the physical subject, the articulated model including two or more rigid bodies interconnected with one another at one or more flexible joints movable within a limited or unlimited range. The parameters include one or more of: sizes, locations and orientations of the two or more rigid bodies.

In various embodiments, the one or more camera image frame sets include two or more camera image frame sets, and the physical constraints include that sizes of the one, two or more constituent (e.g. rigid) bodies of the model are unchanging over all of the two or more camera image frame sets. The locations and orientations of the constituent bodies are subject to variation between different ones of the two or more camera image frame sets.

In various embodiments, the articulated model is a skeleton model representative of a human or an animal. In various embodiments, the articulated model is representative of a non-living and/or inanimate object.

In various embodiments, the one or more initial representations of the physical subject include one or more initial representations of salient points for the physical subject, and the salient points have an anatomical meaning for the physical subject.

In various embodiments, the one or more initial representations of the physical subject includes one or more initial representations of vectors or salient points for the physical subject, each of the one or more initial representations of vectors or salient points including a respective first spatial coordinate and a respective first label, the first spatial coordinate indicating an estimated location, orientation, or both, of a part of the physical subject, the part corresponding to the first label; the one or more enhanced representations of the physical subject includes one or more enhanced representations of vectors or salient points for the physical subject, each of the one or more enhanced representations of vectors or salient points including a respective second spatial coordinate and a respective second label, the second spatial coordinate indicating a location, orientation, or both, of the part or another part of the physical subject, the location, orientation, or both, being constrained according to the model of the physical subject, the part or the other part corresponding to the second label; an initial representation of a salient point of the one or more initial representations of salient points and an enhanced representation of a salient point of the one or more enhanced representations of salient points are representative of a same salient point for the physical subject; the first label of the initial representation of the same salient point matches the second label of the enhanced representation of the same salient point; and the second spatial coordinate of the enhanced representation of the same salient point represents a version of the first spatial coordinate of the initial representation of the same salient point which is constrained according to the model.

In various embodiments, each of the first spatial coordinate and the second spatial coordinate are three-dimensional spatial coordinates.

In various embodiments, the apparatus further comprises an input module configured to obtain the one or more camera image frame sets.

In various embodiments, the input module includes two or more (nominally) synchronized video cameras configured to provide the one or more camera image frame sets or video feeds indicative of the one or more camera image frame sets.

In various embodiments, the apparatus is configured to provide an enhanced training data for training of an enhanced artificial intelligence (AI) module to output inherently constrained motion or still image capture data, the enhanced training data comprising the one or more enhanced representations of the physical subject.

According to an aspect of the present invention, there is provided a method for supporting video-based motion or still image capture, the method comprising, using a computer: receiving one or more initial representations of a physical subject, the one or more initial representations provided based on camera data including one or more camera image frame sets; providing, based on the one or more initial representations of the physical subject in combination with physical constraints specified for the physical subject, one or more enhanced representations of the physical subject, each of the one or more enhanced representations of the physical subject being constrained according to a model of the physical subject, the model incorporating or being configured according to the physical constraints; and providing output data which includes or is based at least in part on the one or more enhanced representations of the physical subject. Other aspects of the method, for example commensurate with aspects of the apparatus as described above, can also be provided.

According to another aspect there is provided a computing apparatus for supporting artificial intelligence (AI) training for video-based motion or still image capture, the apparatus comprising one or more processing modules configured to: receive one or more initial representations of corresponding one or more salient points for a physical subject, the one or more initial representations generated based on camera data including one or more image frame sets, each of the one or more initial representations including a respective first spatial coordinate and a respective first label, the first spatial coordinate indicating an estimated location of a part of the physical subject, the part corresponding to the first label, generate, based on the one or more initial representations in combination with physical constraints specified for the physical subject, one or more enhanced representations of corresponding one or more salient points for the physical subject, each of the one or more enhanced representations indicating a respective second spatial coordinate and a respective second label, the second spatial coordinate indicating location of the part or another part of the physical subject, the location being inherently constrained according to a model of the physical subject, the model incorporating or being configured according to the physical constraints, the part or the other part corresponding to the second label; and provide an enhanced training data for training of an enhanced AI module, the enhanced training data including the one or more enhanced representations or projections onto two dimensions of the one or more enhanced representations, the enhanced AI module configured to output motion or still image capture data for the physical subject following the training, the motion or still image capture data based on the camera data or based on further camera data indicative of the physical subject.

In various embodiments, each of the one or more image frame sets includes multiple image frames, each of the image frames of a same one of the multiple image frame sets being indicative of a real or virtual camera image of the physical subject, at a same time (or nominally a same time) and from a different respective angle.

In various embodiments, the one or more processing modules comprises one or both of: the enhanced AI module; and another processing module configured to generate the one or more initial representations.

In various embodiments, the enhanced AI module is configured to operate as the other processing module.

In various embodiments, the model is an articulated model, and the physical constraints include: articulation constraints indicative of limitations to positions, orientations and/or poses of the physical subject, according to the articulated model for the physical subject, in each of the one or more image frame sets taken individually or in combination.

In various embodiments, the one or more image frame sets includes multiple image frame sets, each of the multiple image frame sets representing a different respective instance in time; and the physical constraints include one or more of: consistency constraints indicative that one or more characteristics of the physical subject are consistent across all of the multiple image frame sets; kinematic constraints, dynamic constraints, or a combination thereof, indicating limitations to changes in position, orientation, pose, or a combination thereof, of the physical subject, as indicated by differences between different ones of the multiple image frame sets.

In various embodiments, the model is an articulated model, and at least one processing module of the one or more processing modules is configured to define parameters of the articulated model of the physical subject based at least in part on the one or more initial representations, the physical constraints including the articulated model, the articulated model including two or more rigid bodies interconnected with one another at one or more flexible joints movable within a limited or unlimited range. The parameters include one or more of: sizes, locations and orientations of the two or more rigid bodies.

In various embodiments, the one or more image frame sets include two or more image frame sets, and the physical constraints include an indication that sizes of the two or more rigid bodies are unchanging over all of the two or more image frame sets. The locations and orientations of the two or more rigid bodies are subject to variation between different ones of the two or more image frame sets.

In various embodiments, the articulated model is a skeleton model representative of a human or an animal.

In various embodiments, at least one of the one or more salient points corresponding to the respective at least one of the one or more initial representations and at least one of the one or more salient points corresponding to the respective at least one of the one or more enhanced representations has an anatomical meaning.

In various embodiments, an initial representation of the one or more initial representations and an enhanced representation of the one or more enhanced representations are representative of a same salient point for the physical subject; the first label of the initial representation matches the second label of the enhanced representation; and the second spatial coordinate of the enhanced representation represents a version of the first spatial coordinate of the initial representation which is inherently constrained according to the model.

In various embodiments, each of the first spatial coordinate and the second spatial coordinate are three-dimensional spatial coordinates.

In various embodiments, providing the enhanced training data comprises, for an enhanced representation of the one or more enhanced representations, and for each camera belonging to a set of one or more real or virtual cameras: determining one or both of: a position, within an output image of the camera, at which the enhanced representation would be indicated by the camera as if a corresponding salient point were visible to the camera, the position determined based on an angle, a field of view dimensions and a location information for the camera; and a distance from the corresponding salient point to the camera, the distance based on at least the location information for the camera. The enhanced training data includes, for each of the cameras belonging to the set of one or more real or virtual cameras, one or both of: the position at which the enhanced representation would be indicated by the camera; and the distance from the corresponding salient point to the camera.

In various embodiments, providing the enhanced training data further comprises: for each camera belonging to the set of one or more real or virtual cameras: generating, based on the model and the angle, the field of view dimensions and the location information for the camera: the output image of the camera, the output image indicative of the model from a point of view of the camera. The enhanced training data includes the output image of the camera, for each of the cameras belonging to the set of one or more real or virtual cameras.

In various embodiments, the apparatus further includes an input module configured to obtain the one or more image frame sets.

In various embodiments, the input module includes two or more (nominally) synchronized video cameras configured to provide the one or more image frame sets or video feeds indicative of the one or more image frame sets.

Aspects further provide for a method and associated computer program product commensurate with the above apparatus. The computer program product includes computer-readable memory having stored thereon statements and instructions which, when executed by a computer, cause the computer to implement the method.

Aspects further provide for a non-transitory computer-readable media containing a program element executable by a computing system to perform a method for supporting video-based motion or still image capture. The program element includes a first program code that when executed by the computing system, configures the computing system to receive one or more initial representations of a physical subject, the one or more initial representations provided based on camera data including one or more camera image frame sets. The program element includes a second program code that when executed by the computing system, configures the computing system to provide, based on the one or more initial representations of the physical subject in combination with physical constraints specified for the physical subject, one or more enhanced representations of the physical subject, each of the one or more enhanced representations of the physical subject being constrained according to a model of the physical subject, the model incorporating or being configured according to the physical constraints. The program element includes a third program code that when executed by the computing system, configures the computing system to provide output data which includes or is based at least in part on the one or more enhanced representations of the physical subject.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art. The phrase “in embodiments” can be interpreted to mean “in one or more, but not necessarily all embodiments.”

### BRIEF DESCRIPTION OF THE FIGURES

Further features and advantages of the present invention will become apparent from the following detailed description, taken in combination with the appended drawings, in which:

FIG. 1A shows a system provided according to embodiments of the present invention.

FIG. 1B shows details of determining, via triangulation, a three-dimensional location of a salient point based on camera image data, and in the reverse process of backprojecting a three-dimensional salient point onto a camera image plane, according to embodiments of the present invention.

FIG. 2 shows a system provided according to other embodiments of the present invention.

FIG. 3A shows a camera image frame showing a human subject, with initial salient points representations shown, according to an example embodiment.

FIG. 3B shows a camera image frame showing a wrist of a human subject, with initial salient points representations shown, according to an example embodiment.

FIG. 3C shows a camera image frame showing a human subject, with initial salient points representations shown, according to an example embodiment.

FIG. 4 shows an image frame set including multiple camera image frames showing the human subject of FIG. 3A, according to an example embodiment.

FIG. 5 illustrates a diagram showing locations and orientations of multiple cameras providing the image frame set of FIG. 4, along with 3D point cloud of salient points, according to an example embodiment.

FIG. 6 illustrates a generated articulated model having parameters based on the 3D point cloud of FIG. 4, according to an example embodiment.

FIG. 7 illustrates a portion of the articulated model of FIG. 6, and shows a difference between enhanced, model-based salient points and initial salient points, according to an example embodiment.

FIG. 8 illustrates a reverse triangulation or backprojection operation by which enhanced salient points in three dimensions are represented as locations in corresponding camera images, according to an example embodiment.

FIG. 9 illustrates an overlay of the generated articulated model of FIG. 6 with the human subject of FIG. 3A, according to an example embodiment.

FIG. 10 illustrates a method for providing enhanced salient point representations for training an AI for motion or still image capture, according to an embodiment.

FIG. 11 illustrates a method for providing enhanced salient point representations for training an AI for motion or still image capture, according to another embodiment.

FIG. 12 illustrates a method for providing enhanced salient point representations for training an AI for motion or still image capture, according to another embodiment.

FIG. 13 illustrates a method for providing enhanced salient point representations for use in motion or still image capture, according to another embodiment.

FIG. 14 illustrates a computer apparatus which may be used according to embodiments of the present invention.

It will be noted that throughout the appended drawings, like features are identified by like reference numerals.

### DETAILED DESCRIPTION

Unless defined otherwise, all technical and scientific terms used herein have the same meaning as commonly understood by one of ordinary skill in the art to which this invention belongs. The numbers and numbers combined with letters correspond to the component labels in all the figures.

Embodiments of the present invention provide for video-based motion or still image capture and supporting systems, in various aspects. Some aspects provide for the generation, provision, or both, of enhanced training data that is used for training an artificial intelligence (AI), machine learning (ML), or other trainable and automated computer systems, or a combination thereof, referred to herein as an enhanced AI module. This can include generating enhanced training data that includes annotated images of one or more subjects. The annotated images include enhanced representations of the one or more subjects identified in a video feed or at least one image frame or other input (e.g., photographs, real or virtual images, real or animated video, etc.), and/or data representative of such enhanced representations. The annotated images are obtained at least in part using or from a model (or a respective model for each identified physical subject), such as an articulated model, which incorporates various physical constraints for the corresponding physical subject.

Motion capture, such as video-based motion capture, refers generally to obtaining information from input data that indicates changes in a subject over time. This generally requires the input data to indicate aspects of the subject at multiple different times. Still image capture is the analog of motion capture applied to a physical subject at a single (nominal) instance in time. For example, still image capture can refer to generating digital data representing a subject based on one or more camera images (or other input) indicative of the subject at a single nominal instance in time.

The model may be generated or parameterized based on a template model that incorporates physical constraints for a particular physical subject type (e.g., human), and initial representations of the respective physical subject that are (e.g., manually, by hand, using a physical measurement system, or using an initial representation generation module that may, although not necessarily, include an AI/ML component) identified in camera images. Initial representations are used to guide generation of the, e.g. articulated, model or parametrization of the template model to obtain the, e.g. articulated, model. The model may be generated based on the physically constrained template model for the physical subject (type) and using the initial representations as a guide for parametrization of the articulated model template to obtain the, e.g. articulated, model of the particular physical subject of images of a given image frame set. This model can be used to generate enhanced representations of the physical subject. The enhanced representations, being obtained from the model that is physically constrained, are accordingly physically constrained.

Some aspects provide for motion (or still image) capture systems that include an enhanced AI module which is usable for motion (or still image) capture, where the enhanced AI module is configured according to such (enhanced) training using the enhanced training data that at least in part includes or is based on the enhanced representations. Following training using the enhanced training data, the enhanced AI module can generate and output inherently constrained representations of a (one or more) physical subject of an input video feed or one or more (real or artificial) image frames. The AI module can generate and provide other types of output, such as data indications of the physical subject, inferences, etc. The AI module can similarly operate on other types of input, such as motion capture input or measurements from other sensors. Because the enhanced AI module is trained using information from the model, the constraints of the model will be inherent to the AI module's operations.

According to embodiments, the (e.g., initial, enhanced, inherently constrained) representations of a physical subject include one or more of: representations of salient points (also referred to herein as salient point representations) for a physical subject, vector representations (e.g., of salient points, rigid bodies such as bones) for the physical subject, representations of a position (e.g. location of subject or part thereof within an image frame, camera view, relative to a reference point), an orientation (e.g. orientation, direction the of subject or part thereof is facing within an image frame, camera view, relative to a reference point), or both, of the physical subject, and pose representations of a pose of the physical subject. Salient point, vector, position and/or orientation, and pose representations may be two-dimensional (2D) representations or three-dimensional (3D) representations. The enhanced AI module, therefore, is trained at least in part using enhanced training data representative or inclusive of enhanced salient pose representations, enhanced vector representations, enhanced position and/or orientation representations, enhanced pose representations, or any combination thereof. The physical subject may be identified in images or images frames of one or more image frame sets, or other input (e.g., photographs, real or virtual images, real or animated video, etc.), derived or obtained from camera data or generated artificially. The physical subject is also referred to herein simply as a “subject” and may be a whole physical subject or a portion thereof. The term “pose” can be used to refer to a position and orientation of a subject or a part (e.g. one or more rigid body) of a subject. Poses of multiple rigid bodies composing a subject can collectively form the pose of the subject. Orientation of a rigid body can include direction of extension of a (e.g. elongated) body, rotation of that body about an axis corresponding to the direction of extension, or a combination thereof.

Salient point representations can be 3D points or 2D points on an image, image frame or a model of a physical subject (e.g. a human, dog, a ball, baseball bat, car, etc.) The image or image frame may be an image of a camera image frame set or an artificial image. The model may be an unconstrained model, e.g. in terms of physical constraints, generated using the triangulated camera data of multiple cameras or a (e.g., articulated) model that incorporates physical constraints, or another constrained model. Each salient point representation indicates or represents location of a salient point which is a physical and/or anatomically representative part of the subject, e.g. a point part, such as a bony landmark such as an end of a bone, or an anatomical landmark such as a center of pelvis, or a physical landmark, such as a fingertip, a center of iris, etc. In cases where the physical subject is non-living, a salient point can be a physical part of the subject, such as a center or a surface point of a ball, a tip of a baseball bat, a center of a car wheel, a frontmost point of a front bicycle wheel, etc. It is noted that an inanimate or non-living object can also be represented using an articulated model, e.g. to represent a vehicle suspension system. A salient point can identify a consistent and identifiable location on or a physical feature (anatomical feature, feature having consistent and know physical location, e.g. bone tip, center of pelvis, center of iris, fingertip, etc.) of the physical subject, at a consistent and identifiable location. In some cases, the feature and its location may not be fully consistently identifiable in a given input, for example because of occlusion. However, the locations on the physical subject or the physical features of the subject, as an ideal, should remain consistent and identifiable, for example using a point coordinate (i.e., a salient point representation), a one or more vector (i.e., a vector representation), or a combination thereof.

Representations of salient points can include labels corresponding to the respective salient points. Labels may, for example, correspond to the anatomical landmark of the salient point, e.g. head of fibula (e.g., has fixed position with respect to fibula distal aspect), a center of iris (e.g., generally has a fixed position relative to the other iris, known predefined range of motion relative to center of nasal bone), a tip of the right index finger (has a fixed position relative to the corresponding distal phalange, etc.) In a non-limiting example, images (e.g., images taken from camera image frame set(s), artificial images) annotated with at least the enhanced 2D representations of salient points may be included in the enhanced training data. Thus, images taken of the subject, or else artificial output images generated based on a model of the physical subject (or artificial images generated based on enhanced representations), along with the associated enhanced representations such as salient points or vectors, can be provided to the (enhanced) AI module and used for training thereof.

Embodiments of the present invention involve the application of physical constraints to a model of a physical subject. The application of constraints will tend to correct or adjust initial representations of salient points on (e.g. annotated) images of a physical subject, where such initial representations of salient points are initially provided by (e.g., identified by, annotated by) an (non-enhanced) AI module or other system (e.g., manually identified, identified using a motion capture suit). According to the correction, enhanced representations of salient points are obtained from the (constrained) model. The physical constraints can represent expected limitations of the physical subject and can include at least consistency constraints, dynamic constraints, kinematic constraints, or a combination thereof, for the physical subject.

For example, for a human or other animal subject, the physical constraints can include or be represented within an articulated skeleton model which limits the range of possible positions, orientations and/or poses of the subject, indicates movement range of various parts, rigid bodies or points (e.g., joints, bones, muscle points, fingertips, center of iris, etc.) within the articulated model, or a combination thereof, and which requires aspects such as bone or other rigid body lengths to be consistent over time. The term “articulated” may refer to a model having two or more parts or rigid bodies connected by a flexible joint having a range of positions, movement or poses predefined according to the physical constraints. Other types of models may also be employed, for example with flexible (plastic or elastic) surfaces (e.g., for a physical subject such as a snake, a gymnastics ribbon, bouncy castle, trampoline, etc.), separate parts of which are not necessarily physically connected but are coupled via certain forces, or the like, such as a baseball bat moving relative to a player's shoulder and/or a ball.

In some embodiments, the articulated model may include two or more physical subjects of a same or different type, e.g., a player and a baseball bat (different physical subject types), a car and a bicycle at an intersection (may be different or same physical subject types, depending on the model template), a dog catching a stick (different physical subject types), or one dancer supporting another dancer (physical subjects of a same type). It is expected that at least some models of physical subjects will have two or more parts of a same or different subjects that are movable relative to one another in accordance with physical constraints, but which are likely coupled together in some manner. Other non-limiting examples of subjects, including vehicles, mechanical devices such as robots, virtual subjects such as avatars or holograms, simple organisms, body organs, or naturally occurring phenomena, can similarly be subject to motion (or still image) capture, using methods and systems disclosed herein, using appropriate physical constraints as long as physical constraints can be applied thereto.

In embodiments, a physical subject is generally defined herein as a complete (e.g., full body human) or a part (e.g., an arm) of a physical or virtual, life or inanimate object that has at least partially definable structure (e.g., skeleton, surface, etc.) that respects at least some definable kinematic, dynamic, or both kinematic and dynamic constraints.

In embodiments, the enhanced representations may then be used in the enhanced training data for training an enhanced AI module to output the output motion (or still image) capture data that is inherently constrained, i.e., constrained as a result of the enhanced training data having included and been based on the enhanced representations that are constrained, and without having physical constraints being explicitly applied or used during the generation and output of the motion or still image capture data by the enhanced AI module (although embodiments of the present invention do not necessarily limit such post-training application of additional constraints). Additionally or alternatively, the enhanced representations themselves may be used as motion (or still image) capture output that is constrained explicitly from having been generated from or using the (e.g., articulated) model, or to generate motion (or still image) capture output, without necessarily training an enhanced AI module using the enhanced representations to generate or identify inherently constrained representations.

Embodiments may also provide for a combination of components, for example including modules for generating and providing the enhanced training data, in combination with one or both of: the enhanced AI module; and an input module which provides training camera image frame sets for example using one, two or more video cameras.

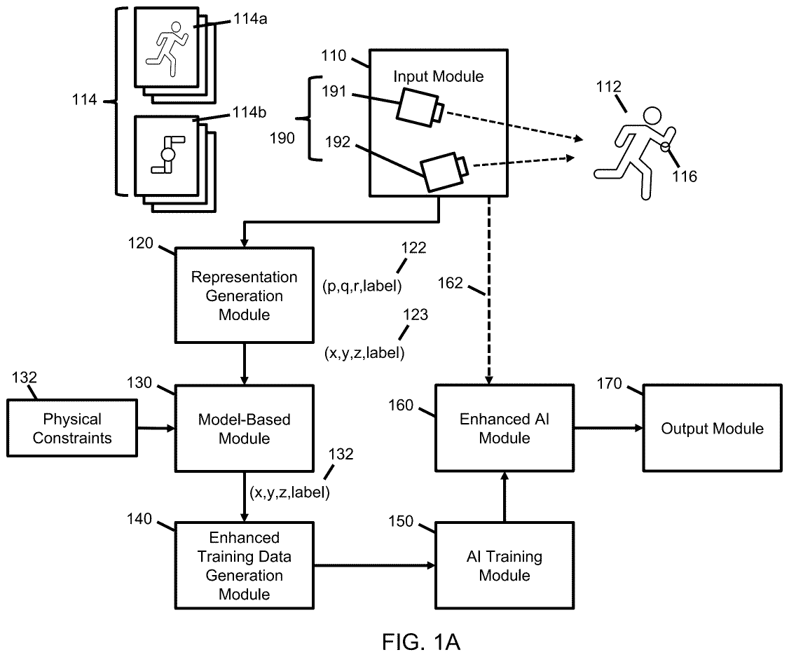

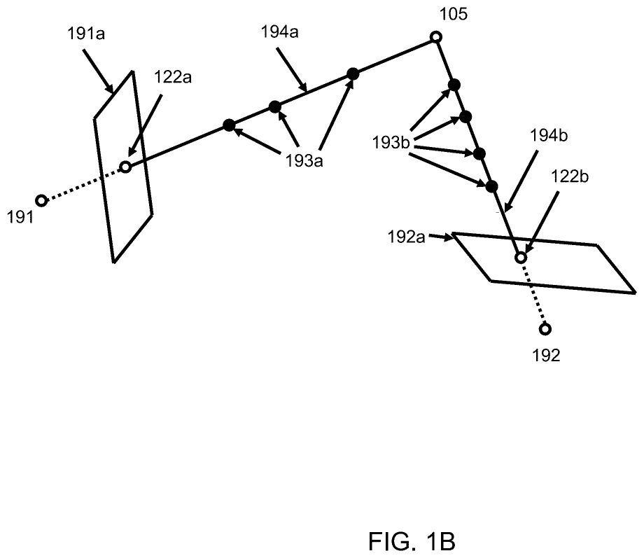

FIG. 1A illustrates an example system of modules, according to embodiments of the present invention. The term “module” is used to refer to a particular component of the overall system which is defined by its functionality. However, it should be noted that multiple modules can be integrated together and may cooperatively perform corresponding functions. Furthermore, it should be emphasized that, in practice, a device operating according to the present invention may not necessarily be partitioned into modules, or may not be partitioned into modules in the exact manner as described herein. That is, the use of modules to describe the present invention is done for purposes of clarity and is not necessarily intended to be limiting.

The system of FIG. 1A includes an input module 110, a representation generation module 120, a model-based module 130, an enhanced training data generation module 140, an AI training module 150, an enhanced AI module 160, and an output module 170. Various ones of the representation generation module, model-based module, enhanced training data generation module, AI training module, enhanced AI module, and output module, or other modules as may be appropriate, may also be referred to as processing modules, e.g. first, second and third processing modules, which may be assigned number labels arbitrarily as needed, e.g. to reflect an order of introduction in a particular discussion context.

In embodiments, one or more processing modules may cooperatively form an apparatus that is configured to support training of an enhanced AI module for video-based motion or still image capture. The motion or still image capture may be video-based according to received input video that includes image frame sets, each having at least one image frame, and the enhanced AI module may be trained to process at least some of the image frames to produce output data. The output data may be any of a variety of types of data, such as images, inferences, trends, predictions, graphical or numerical data, etc. In some embodiments the enhanced AI module captures a motion or still image of one or more physical subjects present in such image frames, to produce output data that is describable as motion or still image capture data.

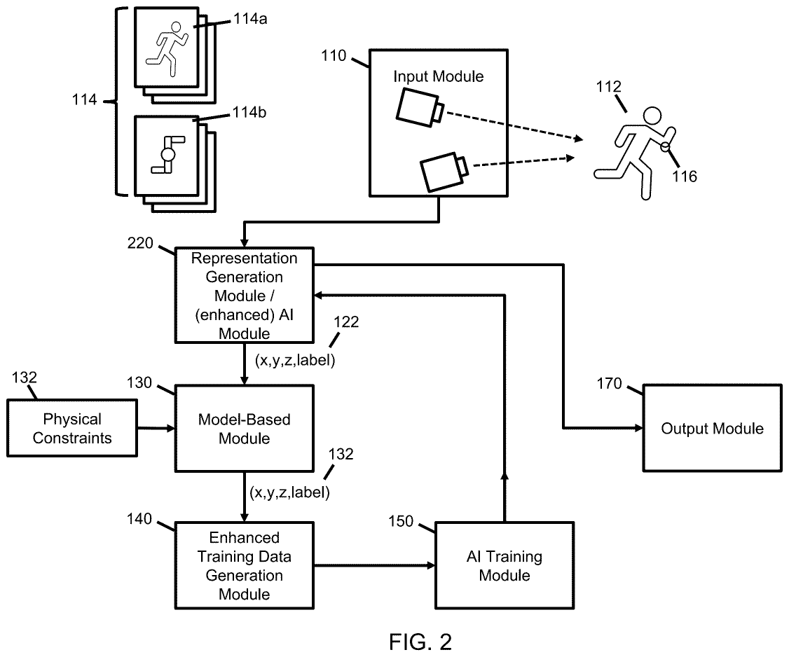

It is noted that in some embodiments the representation generation module 120 also is or includes the enhanced AI module 160 being trained. This particular configuration is illustrated in FIG. 2. For example, an initial (e.g. non-enhanced) version of the (i.e., enhanced) AI module may be trained using a set of, e.g., manually annotated training images of humans or other physical subjects in various poses. Each annotation can indicate an (e.g., preliminary) initial representations within the initial training image. Such an initial version of the AI module can be trained based on these initial training images to identify such initial representations in new images presented thereto that may be subsequently used in generating enhanced representations and enhanced training data to train the initial version of the AI module or another (enhanced) AI module to obtain the enhanced AI module. Notably, such initial training images include representations that are unconstrained (in terms of physical constraints, explicitly and/or inherently).

The representation generation module 120 may alternatively be another module which functions as described below, such as a non-AI module or a different AI module (e.g. an AI module trained on manually annotated or motion capture suit annotated images). A non-limiting example of a non-AI representation generation module is a conventional motion capture system, using markers placed on subjects, motion capture suits, or the like. For example, a physical subject such as a human may wear a motion capture suit or be physically marked with markings indicating, e.g. estimated, salient points or points representative thereof, or other reference points that can be used together with a (e.g. articulated) model of the subject, on their body. The state of the motion capture suit can indicate position and pose of various locations thereof, and these locations can be interpreted as locations of initial salient point representations, or other reference point representations. The locations of markings can be tracked using a camera or other sensors and similarly be interpreted as locations of initial salient point representations. In other non-limiting examples, initial salient point representations may be annotated by hand or may be otherwise physically measured for the physical subject. A similar example may be applied to initial vector representations and initial pose representations.

However, even though in some implementations the initial representations may be obtained manually or using a motion capture suit or the like, advantageously methods and systems disclosed herein can be practised without such and the associated equipment (suit, sensors, etc.), which can be costly and/or prone to other limitations that would be readily understood by a worker skilled in the art, is not necessary. Moreover, the enhanced AI module is trained to output data, such as 3D and/or 2D motion or still image capture data, that is inherently constrained while any representations of the physical subject generated manually or using a motion capture suit or the like are not inherently constrained.

Continuing with respect to FIG. 1, the input module 110 is configured to obtain camera data including one or more image frame sets 114.

As illustrated, the input module 110 may include synchronized video cameras 190 which each include, in their respective fields of view for each camera, such as cameras 191, 192, a physical subject 112. In some cases, two or more such cameras may be included. Cameras may be real or virtual cameras (e.g., obtaining a video of an avatar in a computer game). In other examples, the input module may include one or more video cameras and another one or more input generating systems, such as a motion capture suit system, or a system generating video or images artificially. The cameras are configured to provide the image frame sets directly or indirectly. For example, the cameras may output video feeds in a certain format, where the video feeds are indicative of the one or more image frame sets. The input module may be configured to obtain the image frame sets, whether the cameras are part of the input module or not. The image frame sets can be obtained by processing the video feeds, for example converting a video stream encoded using a standard such as MP4 into a series of image frames. The cameras 190 may be synchronized with one another so that image frames from each camera are obtained at substantially the same time (e.g., as much at the same time as is required, or as technology and equipment permits, as readily apparent to a worker skilled in the art) and allocated to the same image frame set. The term “nominally the same” is used to refer to time instances that are considered to be the same or synchronized for practical purposes, while allowing for some limited difference. Therefore, an image frame set 114 represents multiple substantially concurrent image frames (e.g. 114a, 114b) of the subject 112. Each of these image frames, in the same image frame set, is taken at a same time but from a different respective angle or position, by a camera at a different respective location. The image frames are thus indicative of camera images, in the sense that they are obtained from camera outputs operating with a field of view that includes the (whole or in part) subject 112. Non-limiting examples of image frames include digital or electronic (original or modified) copies of camera images, and printed copies of camera images. Image frames may be indicative of a whole or a portion of respective camera images. For example, content or physical subjects that are not used in generating motion or still image capture data or in generating the enhanced training data, etc., may be cropped, erased or blurred, for example to advantageously protect privacy, adhere with applicable standards or regulations, reduce image size for storage and/or processing, or a combination thereof.

In some embodiments, the image frames of the image frame set may include or be associated with a time indication specific to the set. The time indication may be indicative of a substantially or nominally the same time the images of the same image frame set were obtained at or represent. The time indication may be an actual or artificial time value, a timestamp, a nominal, a sequential indicator indicating an index of a particular image frame set in an indexed series of image frame sets, or a combination thereof.

The image frame set 114 of FIG. 1A includes a pair of image frames 114a, 114b. The first image frame 114a is taken from a first angle using a first corresponding camera 191, e.g. from the side of the subject 112, while the second image frame 114b is taken from a second angle using a second corresponding camera 192, e.g. from the top of the subject 112. In practice, an image frame set may include significantly more than two image frames with corresponding cameras, e.g. tens of image frames obtained from a same corresponding number of cameras.

In embodiments, the cameras are calibrated such that distance from each camera to the subject (e.g., a same reference point on the subject, which may also correspond to a salient point) can be determined. The cameras may be calibrated so that their positions (e.g. within a global coordinate system), angles, and fields of view (e.g. as indicated by zoom level) are precisely known. In some cases, as readily understood by a worker skilled in the art, calibration information for the cameras may be determined, e.g. using suitable software, based on the scene captured by the cameras as depicted in the image frames. The cameras may be calibrated with respect to their lens settings, which are known and may be predetermined and suitably adjusted. The calibration information can be used to at least determine (e.g., calculate, compute) respective camera distances to the (e.g., portion, reference point, salient point of) subject that can be used subsequently in initial representation generation, enhanced training data generation, or the like.

In some embodiments, one or more of the cameras may be virtual cameras. A virtual camera may generate camera data that includes inferred images of the subject not based on light sensors but rather based on other information, such as image data from other cameras or from a virtual environment. The virtual camera generates its camera data to indicate the physical subject as if the virtual camera were at a particular specified location, with a particular specified angle and field of view. Virtual cameras may be used to obtain image frame sets for an avatar in a computer game or a virtual reality environment, for example. In a virtual environment, virtual cameras may suitably positioned and adjusted to obtain suitable camera images from respective virtual camera fields of view. For example, in a three dimensional scene, the image generated by a virtual camera at a given position in the scene and oriented at a given angle can be generated using established computational techniques. One or more cameras may be artificial constructs, for example in case where the camera images are artificially generated, for example using generative AI technology.

In an example embodiment, information indicative of images from a virtual camera may be obtained using a mirror which is in the field of view of one or more other cameras. That is, the virtual camera location may be the mirror location, and the other camera(s) may generate images as if taken by the virtual camera based on reflections of the subject from the mirror. Such a virtual camera may be useful, for example in environments what physically limit positioning of the camera.

In some embodiments, the input module itself may not include cameras. Rather the input module may accept pre-recorded camera data, such as video or image frame sets. Video, as referred to herein, received at or obtained by the input module, refers to a video that, as readily understood by a worker skilled in the art, can be used to obtain one or more image frame sets therefrom.

The representation generation module 120 receives the camera data, including the image frame sets 114, from the input module. Based on this, the representation generation module 120 generates one or more (typically multiple) representations of the physical subject 112. For the purpose of generating enhanced training data, the generated representations are initial representations of the physical subject as described elsewhere herein. The initial representations may, for example be initial 2D representations of salient points, although additionally, in some examples initial 3D representations of salient points may be generated by the representation generation module. In some embodiments several hundred initial representations may be generated for a given image frame set. Each initial representation corresponds to a part (e.g. a salient point, a point part, a rigid body) of the subject 112. An example part 116 of the subject 112, in the vicinity of the elbow, is shown. In case the initial representations are initial 2D representations of salient points, each initial 2D representation of salient point includes a corresponding initial 2D spatial coordinate and a may include a corresponding label. The initial 2D spatial coordinate indicates location of the part of the subject in an image frame and may include a distance from the camera to the salient point, the subject, or a reference point of the subject, as determined (e.g., calculated, computed) by the representation generation module using the camera data. In some case, the distance may be obtained, estimated or computed at another step. The label, if used, also indicates or identifies the part. An example generated initial 2D salient point representation 122, of the form (p, q, r=distance, label), is shown in FIG. 1A, where (p, q) indicates the initial 2D spatial coordinate with respect to the camera coordinate system.

In an example embodiment, the representation generation module may be configured to at least generate initial 2D salient point representations, which may be data indicative of the 2D locations of initial 2D salient point representations on images or image frames of the image frame sets. An initial 2D salient representation can include a (p, q) 2D coordinate of the point (e.g., pixel) identified by the representation generation module as the location of a particular initial salient point representation in a particular image frame. The initial 2D representation or data indicative thereof can further include a distance between the initial salient point representation and the image plane of the camera that was used to obtain the corresponding image or the camera image plane (e.g., distance between salient point 105 and first camera image plane 191a of FIG. 1B); a distance between the camera that was used to obtain the particular image and the subject, the salient point of the subject, or another reference point on the subject (e.g., center of the body of the subject); or a combination thereof. The distance may be computed, e.g. using camera calibration information, or it may be estimated, physically measured, or a combination thereof. Additionally or alternatively, the initial 2D salient point representation or data indicative thereof can include a distance from the salient point to another reference point on the subject (e.g., center of the body of the subject).

In another example embodiment, the representation generation module 120 may be configured to generate initial 3D salient point representations using initial 2D salient point representations and the camera data. An example generated initial 3D salient point representation 123, of the form (x, y, z, label), is shown in FIG. 1A, where (x, y, z) indicates the initial 3D spatial coordinate with respect to a global coordinate system. Additionally or alternatively, another module, such as model-based module 130 may be configured to generate initial 3D salient point representations.

In embodiments, initial vector, position and/or orientation, or pose representations may be generated similarly to the initial salient point representations. For example, initial vector representations may be generated using the initial 2D or 3D salient point representations. Initial pose representations are (e.g., physically, in terms of physical constraints) unconstrained and may be generated using the initial salient point representations, using the initial vector representations, or a combination thereof. In another example, a vector or a combination of vectors may be used to indicate a position and/or orientation of the subject or a part, such as a rigid body or a salient point, thereof. Accordingly, initial representations of the physical subject can include one or more initial representations of salient points for the physical subject, one or more initial vector representations for the physical subject, one or more initial pose representations of a pose of the physical subject in the (one or more) image frame set(s), or a combination thereof.

Generating initial 3D salient point representations can involve triangulation which is based on information indicative of camera locations (e.g., relative to the subject, indicative of distance from the camera to the subject or a particular reference or salient point thereof) and camera pointing angles. For an illustrative non-limiting example, with reference to FIG. 1B, given a salient point 105 of a physical subject, an initial 2D salient point representation 122a is identified in a first camera image plane 191a and has the corresponding initial 2D spatial coordinate indicating position within a coordinate system for the first camera 191, and the same salient point 105 is represented in a second camera image plane 192a and has the corresponding initial 2D spatial coordinate indicating position within a coordinate system for the second camera 192, then this information can be used to identify or determine a corresponding initial 3D spatial coordinate of the initial 3D representation of salient point 105 within a global coordinate system. This 3D spatial coordinate can be determined for example by identifying a first set of candidate points 193a in the global coordinate system, arranged along a first line or ray 194a (more generally all points falling on the line or ray 194a), that would result in the initial salient point representation being located at the first 2D spatial coordinate in the coordinate system for the first camera image plane 191a, identifying a second set of candidate points 193b in the global coordinate system, arranged along a second line or ray 194b (more generally all points falling on the line or ray 194b), that would result in the initial salient point representation being located at the second 2D spatial coordinate in the coordinate system for the second camera image, and then determining the 3D spatial coordinate as the point of intersection of the first line or ray 194a with the second line or ray 194b. Notably, the point of intersection of the first line or ray 194a with the second line or ray 194b may coincide with the (approximate, estimated location of) the corresponding salient point, for example with a degree of probability. Additionally or alternatively, distances between the salient point 105 or another reference point of the physical subject and cameras 191, 192 or their respective image planes 191a, 192a may be used in determining the 3D spatial coordinate.

Backprojecting, as referred to herein, can involve for example a process reverse to the above, in which a salient point 105 and camera points 191, 192 define lines/rays 194a, 194b, and the intersection of such lines/rays with camera image planes 191a, 191b define the backprojected representations 122a, 122b of the salient point 105.

In another non-limiting example, a location of a salient point representation could be directly inferred using, for example an AI/ML component, and is not necessarily limited to a line intersection alone. Such lines or rays may be used in selecting a point based thereon that satisfies some requirements (e.g., removing outliers, optimizing sparsely to minimize distances, etc.).

The model-based module 130 is configured to generate a model of the physical subject. The generated model may be an articulated model of the physical subject, or another type of model. The model is generated using a template model for the physical subject type (e.g., human, dog, car, bicycle). The template model is constrained according to physical constraints for the physical subject type and incorporates such constraints therein, for example, as a set of limitations to relative sizes, locations, and range of motion of rigid bodies, parts, and/or points of the template model. The template model may be a 3D template model, for example, configured according to the physical constraints. The template model may be data representative of such physical constraints, for example as a set of rules and/or limitations. The model is generated based on the initial representations of the physical subject using such initial representations, generated using (training) image frame set(s), as a guide to parametrize the template model.

The model may be an articulated model that includes two or more rigid bodies (e.g. or a same or different subjects) interconnected with one another at one or more flexible joints movable within a limited or unlimited range. The model may include two or more parts movable relative to one another (e.g., tip of a baseball bat, players hand holding the baseball bat, and a baseball). The model may include one or more flexible surfaces. The model may be a model of a single (e.g. movable) rigid body.

In an example embodiment, the model may be generated by combining the initial 3D salient point representations, as output or provided by the representation generation module 120 (or in some embodiments, the model-based module may be configured to obtain the initial 2D salient point representations form the representation generation module and locally generate initial 3D salient point representations as described elsewhere herein), with physical constraints for the physical subject 112, to produce more accurate (consistent, constrained) information (e.g., data) indicative of motion and/or position/orientation/pose of the physical subject. Such combining may include using the template model for the subject type that is inherently constrained, such as a model of a human skeleton for example for which bones and their respective possible positions (poses) with respect to each other are constrained in accordance with known ranges of motion and relative body components dimensions of a human body. The model-based module may overlay a 3D point cloud of initial 3D salient point representations with the (3D) template model such that the generated model matches or aligns with the 3D point cloud, e.g. within a certain predefined tolerance, probability or accuracy. Such matching essentially matches the pose of the model to the pose the physical subject represented by the 3D point cloud (or, similarly, a plurality of initial 3D vector or pose representations) as appearing in (one or more, where pose is constant) image frame sets, and can include configuring sizes, locations and orientations of the two or more rigid bodies of the model. Notably, since the 3D point cloud is generated using initial representations as identified in or obtained from the actual image frames that include the physical subject, it consequently represents the same poses of the physical subject as those of the image frames. The template model is parametrizable (e.g., scalable and configurable) to assume the same (e.g., with a certain level of accuracy or probability) pose of the subject in the image frames when it is combined with (e.g., overlayed onto, matched with) the 3D point cloud of initial salient point representations.

In embodiments, initial vector, position and/or orientation, pose representations, or a combination thereof may be used similarly to the initial salient point representations to parametrize a template model in order to generate the model, such as the articulated model, for the physical subject. For example, initial vector representations may be combined to generate an initial 3D vector representation of the physical subject, similarly to the 3D point cloud discussed above, and used to parametrize the template model. Initial pose representations may be similarly combined to generate an initial 3D pose representation of a pose of the physical subject and used to parametrize the template model. Notably, prior to parametrization, the 3D point cloud, the initial 3D vector representations, initial 3D position and/or orientation representations, and the initial 3D pose representation are (e.g., physically, in terms of physical constraints) unconstrained having been generated using corresponding initial representations that do not incorporate physical constraints. Although initial representations, as described herein, do not incorporate physical constraints, in some embodiments a representation generation module, depending on its configuration, may generate at least some initial representations that are at least partially constrained. The embodiments disclosed herein, however, do not require the initial representations to be constrained but are nevertheless operable in such cases.

A vector can describe the position and orientation of a rigid body of the articulated model, for example with three entries describing the 3D spatial location of an endpoint, three entries describing the 3D direction in which the rigid body extends, and up to three more entries describing the rotation of the rigid body about this or another direction.

In embodiments, the model is therefore generated based at least in part on the physical constraints for the physical subject in combination with the (training) camera image frame set(s) indicative of the physical subject.

The output of the model-based module may include the model that is parametrized (e.g., scaled and configured) in accordance with the 3D point cloud or other initial 3D representations of the physical subject. Since the model incorporates or is configured according to physical constraints, enhanced representations that can be identified on and obtained from the generated model are, therefore, constrained accordingly. Such enhanced representations of the physical subject can be defined as being at a fixed locations relative to corresponding rigid bodies of the model. The enhanced representations are generally overall more accurate and coherent with respect to the actual physical subject and its (e.g., anatomical) structure and range of motion and poses as having been generated from the model that incorporates physical constraints for the physical subject. The output of the model-based module may be provided in the form of enhanced representations of salient points (or data representative thereof), enhanced vector representations (or data representative thereof), enhanced position and/or orientation representations (or data representative thereof), enhanced pose representations (or data representative thereof), or a combination thereof, for the physical subject. The enhanced representations may include corresponding 2D representations, 3D representations, or both. For example, the model-based module may output a 3D pose representation corresponding to a pose of the subject in a respective image frame set, which can then be backprojected, e.g. by an enhanced training data generation module, into at least some of the individual image frames of the corresponding set to obtain respective 2D pose representations. Additionally or alternatively, the model-based module may output a 2D pose representation corresponding to a pose of the subject in a respective image frame of an image frame set, using camera data to generate such 2D pose representation as if seen by a corresponding camera.

In another example, the enhanced 3D salient point representations may have a similar format (e.g. (x, y, z, label) format) as the initial 3D salient point representations. Indeed, the labels of some or all of the enhanced 3D salient point representations may, although not necessarily, match the labels of the initial 2D, 3D, or both, salient point representations, and thus may represent location-corrected constrained versions of the initial representations of salient points.

Notably, the enhanced representations may be of any type (i.e., enhanced salient point representations, enhanced vector representations, enhanced position and/or orientation representations, enhanced pose representations, or a combination thereof) irrespective of the type of initial representations used in parametrizing the model of the physical subject. The type of the generated enhanced representations may be selectable and selected, for example according to training requirements for training of an enhanced AI module, output format requirements for the motion or still image capture data, resource requirements (e.g., computing, time, memory, storage, etc.), or a combination thereof.

In some embodiments, the model-based module, or another processing module, may be configured to output motion or still image capture data that at least includes or is based at least in part on one or more enhanced representations of the physical subject. Such output motion or still image capture data may, although not necessarily, be used in generating the enhanced training data, as described elsewhere herein. In itself, such output motion or still image capture data is constrained according to the model.

In embodiments, a label may be used for example to associate an initial representation with a particular salient point representation, pose, position and/or orientation, rigid body or part of the articulated model of the physical subject, and further with a particular location on such a rigid body. Labels can tie each particular initial representation to corresponding physical constraints for the associated salient point representation, pose, position and/or orientation, rigid body or part of the articulated model, advantageously facilitating structuring of data indicative of initial representations and model parametrization. The label may be a descriptive label with (e.g. anatomical) meaning, or another unique label that does not necessarily have any other meaning, such as a number, a letter, or a combination thereof. In one non-limiting example, a label for a salient point representation may indicate the corresponding anatomical point or part of the physical subject, such as center or left iris, tip of right index finger, head of right fibula, etc. In another non-limiting example, a label for a vector representation may indicate the corresponding anatomical rigid body or part of the physical subject, such as right femur, medial meniscus to the lateral meniscus of the right knee, center to center of both irises, etc. In a further non-limiting example, a label for a pose representation may indicate the corresponding pose of the physical subject (or a portion thereof), such as right hand in a thumbs up position with the thumb pointing down, subject in a squatting position with indicated angles of knee and hip joints, etc.

In some embodiments, the label may be omitted from some or all of the initial representations. In such cases, the representation generation module or the model-based module may be configured to determine, infer, or assign labels in order to facilitate structuring the data indicative of the initial representations.

In an embodiment, initial salient point representations can include respective first labels and respective first (e.g., 3D) spatial coordinates corresponding to the first labels and indicating an estimated location of a part of the physical subject. Similarly, enhanced salient point representations of the same subject can include respective second labels and respective second (e.g., 3D) spatial coordinates corresponding to the second labels and indicating an estimated location of a same part as the corresponding initial salient point representations or of another part of the physical subject. In cases where a pair of such initial and corresponding enhanced representations are representative of a same salient point for the same physical subject and the respective first label matches the respective second label, the respective second coordinate represents a version of the corresponding first spatial coordinate that is constrained according to the model.

In some embodiments, label corrections may be made. Enhanced representations with labels other than those of the initial representations may be generated. For example, based on two or more initial representations of salient points indicating physical features such as bony landmarks, an enhanced representation of a salient point indicating the presence and location of a physical feature not indicated by the initial representations may be generated. For example, initial 2D salient point representations with labels of a human hand that are representative of the salient points of the five fingertips, distal ends of the five metacarpal bones, and tips of ulna and radium bones may be generated, while additional enhanced representations of salient points representative of, for example, some or all of the phalangeal and carpal bones of the wrist can be generated and have corresponding new labels, and be output by the model-based module according to the (e.g., articulated) model generated based on the initial representations of salient points.

In more detail, with respect to correcting the location of a salient point representation, a salient point representation identified by the representation generation module 120 may have a first label (e.g., added, associated to the respective salient point representation by the representation generation module or a component thereof, or by another suitable configured module), and a corresponding salient point representation identified by the model-based module 130 may have a same matching label. In this case, the spatial coordinate of the enhanced salient point representation identified by the model-based module represents a corrected version of the spatial coordinate of the corresponding initial salient point representation identified by the representation generation module 120. The location of such spatial coordinate of the enhanced salient point representation indicating a location of a part of the physical subject is constrained according to the model.

By applying or importing physical constraints, the model-based module 130 may produce improved indications of salient point representations of the physical subject, for example to overcome limitations of the representation generation module 120. For example, as mentioned above, where the representation generation module 120 includes an (non-enhanced) AI or ML component, the identified initial (salient point, vector, position, orientation and/or pose) representations may include positional errors due to inaccuracies in training data, or limitations in the AI/ML's internal representations. The model-based module may generate a (e.g. articulated) model for the (one or more) physical subject based on physical constraints 132, for example as incorporated into a template model of the physical subject type. Additionally or alternatively, the model, template model, or both may be received, e.g., from a database, another module, a third party, etc., or a combination thereof configured to provide such a model. For example, for a human or animal subject, the model-based module can generate a skeleton model. Other articulated models for other subjects, e.g. with two or more interconnected and relatively movable rigid bodies, or a single rigid body, can be similarly produced or otherwise obtained. In some examples, individual models for different subject may be generated and combined into a combined model for such subjects.

Physical constraints 132 for the skeleton model can include, for example, a condition that bones in the skeleton model do not change size over time, that bones can be oriented with respect to one another over a certain limited range of angles, that changes in poses over time are limited (e.g. in terms of speed or acceleration) due to constraints such as force limitations, that only certain poses or sets of poses are allowed due to effects of gravity or other forces, etc. A variety of kinematic, dynamic, consistency constraints, or a combination thereof can be imposed, as described elsewhere herein. The physical constraints 132 can be predetermined for a given type of physical subject (e.g. human). Physical constraints and associated models can be generated manually or by other appropriate systems, for example based on observation and investigation of appropriate example subjects.

The model can be parametrized according to a set of parameters which can be defined while respecting the physical constraints. These parameters may be defined based on the initial representations (e.g., from the representation generation module 120). The parameters can include, for example, dimensions (e.g. lengths) of rigid bodies (e.g. bones), positions and orientations of such rigid bodies (e.g. in three-dimensional space), a set of standard salient points or rigid bodies of an articulated model that are present or absent and, where present, their labels and positions in the model. Some parameters can be scalable or be scaled cooperatively with other parameters, such that the model can be correspondingly scaled, for example to match size and pose of the generated 3D point cloud representation of the subject. For a given image frame set, the parameters can indicate the relative or probabilistic locations of the salient point, vector, position, orientation and/or pose representations which are present, for example within a global three-dimensional coordinate system. The locations of salient points, vectors position, orientation and/or pose representations can be represented indirectly by the parameters, for example since the parameters can indicate positions, orientations and sizes of rigid bodies, and the salient points, vectors position, orientation and/or pose representations are defined to be at certain locations on or relative to such bodies.

The physical constraints may include articulation constraints indicative of limitations to possible poses of the physical subject type, according to an articulated model for the physical subject. In other words, the articulated model can be configured to match poses of the physical subject in each camera image frame set. The articulated model indicative of the articulation constraints can be a (e.g., human, animal) skeleton model, for example, defining bones and joints, possible respective positions, possible range of motion, and relative dimensions thereof, of a human or animal subject. Selection of an appropriate template model can inherently define physical constraints, since the model defines certain rigid bodies (e.g. bones), their interconnections (e.g. joints) and limits to the relative motion of the rigid bodies (e.g. joint motion ranges).

Particularly where multiple image frame sets (containing at least one image frame each) each representing a different respective instance in time (indicating motion of the subject) are provided, the physical constraints may include consistency constraints indicative that one or more characteristics of the physical subject are consistent across all of the multiple image frame sets. For example, a consistency constraint may require that bones or other rigid bodies do not change dimensions (size) between image frame sets, and thus a consistent set of dimensions (e.g. length, width) for each such bone or rigid body is defined. Additionally or alternatively, the physical constraints may include kinematic constraints and/or dynamic constraints, indicating limitations to changes in position, orientation, pose, or a combination thereof, of the physical subject, as indicated by differences between different frames of the multiple image frame sets. For example, a kinematic or dynamic constraint may impose limits on displacement of the physical subject or portions thereof between frames, given corresponding limits on forces, momentum, or the like. The force or momentum limits can be predetermined or based on information obtained from the image frame sets. A kinematic or dynamic constraint may impose limits on allowable poses or trajectories of a subject, for example based on the presence of gravity or other forces which may be assumed or inferred from image frame sets.

In various embodiments and as already mentioned above, the model-based module can parametrize a model (e.g. appropriate human or animal skeleton model) according to parameters obtained based on the initial representations as received from the representation generation module 120, and certain physical constraints which may be inherent or additional to the template of the model. As above, physical constraints for the model can include for example the number of rigid bodies (e.g. bones) in the model, how they interconnect, and the limitations on relative motion of the rigid bodies (e.g. limits to joint motions in one or more directions). Accordingly, the model may thus include two or more rigid bodies interconnected with one another at one or more flexible joints. The joints are movable within a limited or unlimited range. Certain parameters (e.g. rigid body dimensions, or related parameters such as sizes of physical subject or portions thereof, or ranges of motion of joints) may be imposed in a way that is consistent over all of the image frames and image frame sets. That is, (consistency) constraints may require that such parameters are unchanging over a sequence of image frame sets representing the same subject, while parameters themselves specify model parametrization with respect to the actual physical subject of the image frame set(s). Certain parameters may correspond to the subject as it appears in a corresponding image frame set, e.g. absolute or relative positions and orientations of rigid bodies of the articulated model, indicating subject pose. Accordingly, parameters of the model may indicate, for any given image frame set taken individually, the position, orientation and/or pose of the physical model or its constituent parts in association with that image frame set. The model parametrized according to parameters can indicate or be used to indicate a particular position, orientation and/or pose (e.g. as a set of numerical values defining a configuration of the model and its constituent rigid bodies), which corresponds to that of the subject in the corresponding image frame. Parameters can be used to, at least in part, match a pose of the model to the pose of an image frame set as indicated, at least in part, by the parameters.

In some embodiments, where camera data includes two or more (training) image frame sets and the model is constrained in that sizes of the two or more rigid bodies thereof are unchanging over all of the image frame sets (i.e., corresponding to the unchanging nature of the sizes of rigid bodies, such as bone lengths of a human or length of a baseball bat), the locations and orientations of the two or more rigid bodies are subject to variation between different ones of the two or more training camera image frame sets. Such variation can correspond to the subject moving or changing pose, for example.

The enhanced training data generation module 140 is configured to generate enhanced training data in an appropriate format for training a given (non-enhanced) AI module to obtain the enhanced AI module.

Additionally, the enhanced training data generation module 140 or another training data generation module may be configured to generate (non-enhanced) training data for initial training of an (initial) AI module, which may include same or different AI/ML component as the subsequent enhanced AI module, to train the (initial) AI module to generate or identify initial representations. For example, the (initial) AI module may be trained based on two-dimensional camera images to learn to identify initial representations for a physical subject (of a predetermined type, e.g. human), based on annotated example images or data obtained using motion capture suit, for example. In this case, the enhanced training data generation module 140 or a similar module would not necessarily be required to communicate with the model-based module and can be configured to generate appropriate annotated example images without the use of the model or enhanced representations or data indicative thereof.

When generating the enhanced training data, the output, or annotations thereof, generated by the training data generation module 140 may be or may be based on the enhanced representations as output by the model-based module 130. Accordingly, the enhanced training data may include or be based on the enhanced representations as provided or output by the model-based module 130. In a non-limiting example, the enhanced training data or output images included therein may include enhanced salient point representations at certain locations of real or virtual image frames, as obtained through a backprojection operation which maps the enhanced 3D representations onto two-dimensional planes of camera fields of view to obtain or generate enhanced 2D representations and annotate (e.g., mark, indicate, overlay) them in the image frames, which may be real images or artificially generated images.

The enhanced training data may include labels for the enhanced representations, in which case the enhanced AI module can be trained to include labels for (e.g., all or selected) inherently constrained representations generated thereby, as described elsewhere herein. As discussed elsewhere herein, the enhanced representations for the enhanced training data are generated based on a model of the physical subject that is generated based at least in part on one or more (training) camera image frame sets. Such enhanced representations of the physical subject correspond to physical locations on the physical subject and are constrained according to the model. Obtaining such enhanced representations involves generating the model of the physical subject and subsequently generating the enhanced representations based on or from the model.

More generally, the enhanced training data can include images (e.g., image frames, output images) of a physical subject from one or more image frame sets obtained using one or more real or virtual cameras configured to provide training camera data. The images can be real images or artificial images, e.g. generated from a model. The enhanced training data can further include enhanced representations that include one or more enhanced representations of salient points for the physical subject in corresponding images, one or more enhanced vector representations for the physical subject in corresponding images, one or more enhanced pose representations of a pose of the physical subject in corresponding images, or a combination thereof.

In various embodiments, where the model-based module 130 is configured to provide a three-dimensional (e.g., articulated) model of a physical subject in one or more poses as defined according to the initial representations based on corresponding image frames and frame sets, or at least corresponding enhanced 3D representations obtained from the model, the enhanced training data generation module 140 can project the enhanced 3D representations, within a global three-dimensional coordinate system, onto corresponding (i.e., same pose of the subject) one or more planes each representing a two-dimensional coordinate system of image frames of one or more image frame set, a process referred to herein as backprojection.

To generate enhanced training data that includes enhanced 2D representations, the enhanced 3D representations are projected onto (at least some of) same starting image frames that were initially used for identifying the initial 2D representations. Notably, since projecting is done from three dimensions to two dimensions, and given that the (e.g. articulated) model can be configured to assume a range of poses not present in the image frames where initial salient point representations were identified, projecting may be done onto image frames of the same subject that are different from the starting image frames. For example, if 1000 sequential image frame sets were obtained using multiple cameras depicting the subject in a first pose followed by a second pose, a first subset of image frame sets corresponding to images frames of the subject in the first pose may be used to generate initial representations that are subsequently used in parametrizing the model for the subject in the first pose. Given that the generated model can be configured to assume poses other that those corresponding to the initial representations, a user may provide an instructional input (e.g., select another pose from a database of poses for the model) to the training data generation module 140 to obtain the model and corresponding enhanced 3D representations for the second pose of the subject, which can be projected onto a second subset of the image frame sets that depict the subject in the second pose. This may be advantageous, for example if the subject is partially obscured by an object in at least some image frames of the second subset of image frame sets. This may also be advantageous where artificial images may be used in the enhanced training data instead of the original image frame sets used to generate the initial representations. Additionally or alternatively, this may advantageously decrease (e.g., computing) resources associated with generating of the initial salient point representations and the corresponding generating of the model, while enabling to generate enhanced training data for a larger number of image frames that were initially used for generating the initial salient point representations.

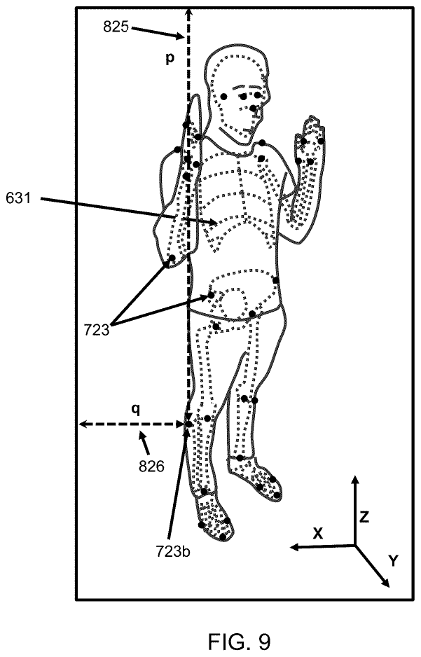

In an example embodiment, the image frames of the enhanced training data can include respective backprojected enhanced pose representations obtained from the model itself in the poses corresponding to the poses of the subject in respective image frames. The backprojected pose representations can be physically scaled, aligned and consistent with the pose of the subject (e.g., as illustrated in FIG. 9).

For example, for each real or virtual camera, angle, field of view dimensions and location information for the camera can be determined and included for example in the camera data. This information can be expressed as a set of vectors. A first vector, expressed in the global coordinate system, can indicate the location of the camera. A second vector, also expressed in the global coordinate system, can indicate a direction in which the camera is pointing. Another value or set of values can indicate the field of view of the camera (e.g. the angle of a cone centered on the second vector).

In case of enhanced salient point representations, the location of an enhanced 2D representation of a salient point within a camera's field of view can be expressed in a local planar coordinate system indicative of the coordinates, in the camera's resulting image frame, of that point representation. For example, a first camera can define a p and q axis which originate at the end of the above-mentioned first vector and which are both orthogonal to the above-mentioned second vector. An r axis can also be defined which is parallel to the above-mentioned second vector. A point in the global coordinate system can be projected onto a plane defined by the p and q axes, to define a resulting point on the plane which indicates the projected point representation at which the first camera would register this point within its local coordinate system. Distance from the point to the p-q plane or the projected point, either along the projection or along the r axis, can also be indicated. FIG. 1B illustrates this, with the p and q axes falling within a camera image plane e.g. 191a and the r axis being perpendicular to such a camera image plane. The enhanced 2D representations of salient points can be displayed on the image frame at appropriate locations, determined according to backprojection. This non-limiting example illustrates roughly how a point in the global coordinate system can be expressed as a point in a camera's local coordinate system, however other approaches may also be used. Other cameras and their local coordinate systems can similarly be defined, and the same point in the global coordinate system can define points in these other local coordinate systems via similar projections.

Accordingly, the enhanced training data generation module can generate, for each (real or virtual) camera and each enhanced 3D salient point representation, a position within a camera's field of view at which the salient point would register to the camera (be displayed in the camera's generated image frame) as if this point were visible to the camera, with the enhanced point representation being located at its corresponding three-dimensional spatial coordinate (in the global coordinate system). The enhanced training data may include the position within the camera field of view for each camera. The enhanced training data may include the distance to the camera. This allows the enhanced training data to be expressed in the same format as data that would be received from cameras that are trained on a physical subject. Accordingly, the enhanced training data is in an appropriate and useful format for enhanced AI module training.

The enhanced training data can include images, such as output images, of the (e.g. articulated) model of the physical subject, backprojected onto the image planes of one, two or more cameras, or onto the corresponding image frames. These images of the model can be artificial, generated images, and can include enhanced salient point representation, enhanced vector representations, enhanced pose representations, or a combination thereof. The enhanced representations can accompany the image frames, e.g. as backprojected location and label data.

The AI training module 150 is configured to interface with the enhanced AI module 160 to perform training thereof. Training of the enhanced AI module can be performed in a variety of ways as will be readily understood by a worker skilled in the art. Accordingly, a detailed description of the training operation is omitted here. Generally, the AI training module 150 uses the enhanced training data provided to it to induce the enhanced AI module to adjust its internal parameters and/or representations in accordance with a training methodology such as supervised learning, unsupervised learning, etc.

The AI training module can present example images, such as image frames or artificially generated output images, of physical subjects, generated as described above (using backprojection), to the (enhanced) AI module, and the (enhanced) AI module can attempt to identify inherently constrained representations (e.g. locations and optionally labels) in such example images. The AI training module can then compare these AI-identified representations to the actual (backprojected) ground truth enhanced representations combined with the corresponding image frames as generated above. The difference between AI-identified inherently constrained representations and ground truth enhanced representations can be used to determine losses which are used as feedback to further train the (enhanced) AI module. Training may involve taking an input (e.g. as ground truth), such as 2D or 3D salient points, vectors, position, orientation and/or pose, along with an image that corresponds to that input. The AI module is created to process the image to predict the input or data obtainable from the input. The prediction is then compared to the input and the AI module is adjusted to compensate for the difference between the prediction and the input.

At least in part as a result of the training using the enhanced training data, the enhanced AI module 160 may be configured to generate inherently constrained representations for one or more subjects of one or more image frame sets. This generating of the inherently constrained representations may operate similarly to the generating of the initial representations by the representation generation module 120, where the representation generation module 120 is or includes an AI/ML component that is or is similar to the AI module to be trained to obtain the enhanced AI module, as described elsewhere herein. The enhanced AI module 160 can additionally or alternatively be configured to perform other operations, such as predicting or extrapolating motions, measuring distances, speeds or angles, generating animations, or generating suitable pattern recognition or animation information (other than inherently constrained representations), or the like. Additionally or alternatively, another module may be provided and suitably configured to perform such one or more operations. The enhanced AI module 160 may incorporate AI characteristics such as machine learning, deep learning, neural networks, or other characteristics that are configurable through training operations. More generally, the enhanced AI module may be configured, at least after or as a result of the training, to output motion or still image capture data for the physical subject or similar physical subjects. This motion or still image capture data is based on camera data such as image frames or image frame sets of one or more physical subjects. The output motion or still image capture data is inherently constrained and may include any one or more of inherently constrained salient point representations, inherently constrained vector representations, and inherently constrained pose representations for the one or more physical subjects. The inherently constrained salient points representations (or corresponding salient points) and inherently constrained vector representations can have, where appropriate (i.e., based on the physical subject type) an anatomical meaning for the physical subject, e.g., representing bony landmarks or joints, or other landmarks such as a center of an iris or a fingertip, or a corresponding reference location.

In some embodiments, following training using the enhanced training data and the training dataset inclusive thereof, the enhanced AI module 160 can receive information, such as camera data, directly from the input module 110 (or from a different input module having one, two or more cameras or other image sources) and to generate and output inherently constrained representations.

The output module 170 is configured to output results, such as output motion (or still image) capture data, from the enhanced AI module in a useful format, or to generate and produce other output based on results from the enhanced AI module. The output module may, in some embodiments, be integrated and operate cooperatively with the enhanced AI module.

In embodiments, the output motion (or still image) capture data may be visually representable as a model of the physical subject, e.g. as an inherently constrained pose representation of a pose of the physical subject, or a portion thereof. The output motion capture data that can be visually represented in 3D, even when the camera data was obtained from or provided by a single camera. In other words, the enhanced AI model may infer the inherently constrained 3D representations (e.g., the 3D point cloud, 3D pose) from 2D input data (i.e., camera data that includes image frame sets). The output motion capture data may be visually representable as a 3D point cloud, or a sequential a series of 3D points. The output motion capture data may be used to produce a visual overlay of inherently enhanced 2D salient point representations, inherently enhanced 2D vector representations, inherently enhanced 2D pose representations, or a combination thereof, for example over the obtained image frame sets or corresponding camera video. The output motion capture data may be used in generating a virtual representation (e.g., an avatar, an animation) of the physical subject and movement thereof that corresponds to the obtained image frame sets of the camera data or corresponding camera video.

In embodiments, the enhanced AI module 160 may be configured, as a result of or following the training, to process the inherently constrained representations to generate and output the motion or still image capture data such as an animation of the physical subject according to at least a portion of the camera data. The enhanced AI module 160 may be configured to output a three-dimensional computerized model of the physical subject. The enhanced AI module 160 may be configured to output a visual overlay of the motion or still image capture data with at least a portion of the camera data. The enhanced AI module 160 may be configured to output indicator data for the physical subject. The indicator data can be indicator data indicative of one or more of: a speed of the physical subject between two or more camera image frames of the one or more camera image frame sets; one or both of a distance between two salient points of the physical subject and an angle between the two salient points of the physical subject relative to a reference point; and one or both of a distance between a salient point of the physical subject and a further salient point of a further physical subject, and an angle between the salient point of the physical subject and the further salient point of the further physical subject of the camera data relative to a reference point, the one or more camera image frame sets further indicative of the further physical subject.

Referring now to FIG. 2, as mentioned above, in various embodiments, the salient point generation/AI module 220 includes the representation generation module 220 and the (enhanced) AI module 160 described elsewhere herein. Initially, the representation generation/(enhanced) AI module 220 can be sufficiently (e.g., initially, partially) trained so that it is operable to generate the initial representations for the subject. This initial training can be performed, as described elsewhere herein, for example based on camera data showing subjects (e.g. humans in various poses) along with annotations showing initial representations for the subjects in the camera data. The annotations can be obtained via manual entry, for example, or from a previous iteration of the present invention, or from another automated process, or from a combination thereof. Alternatively, the representation generation/(enhanced) AI module 220 can be provided already trained to generate initial representations.

In embodiments such as illustrated in FIG. 2, the representation generation/(enhanced) AI module 220 can operate to identify initial representations, which are potentially and likely structurally and/or anatomically inaccurate, at least initially. Then, the present invention operates to provide, via the model-based module and the enhanced training data generation module, to generate enhanced representations, which are used to generate enhanced training data used to further train or retrain the representation generation/(enhanced) AI module 220 and subsequently, following training using the enhanced training data, the inherently constrained representations. Such representation generation/(enhanced) AI module 220 trained using the enhanced training data, becomes similar to the enhanced AI module and is configured to generate motion (or still image) capture data as described elsewhere herein.

In an embedment, the representation generation/(enhanced) AI module 220 can incorporate the output module and output and optionally process the output motion (or still image) capture data that is suitably represented, as described elsewhere herein.

Various modules, such as the representation generation module 120, model-based module 130, enhanced training data generation module 140, AI training module 150, enhanced AI module 160, and output module 170, can be provided using a computer processor or a plurality of computer processors, or other processing hardware which may involve various components which are digital, analog, electronic, photonic, or the like. The same processor or other processing hardware, or set of processor or other processing hardware, can be used to operate multiple modules. Various modules may be connected locally, or remotely, physically, or wirelessly (e.g., Wi-Fi™, Bluetooth™, etc.).

Embodiments of the present invention will now be described with respect to certain drawings, by way of an example.

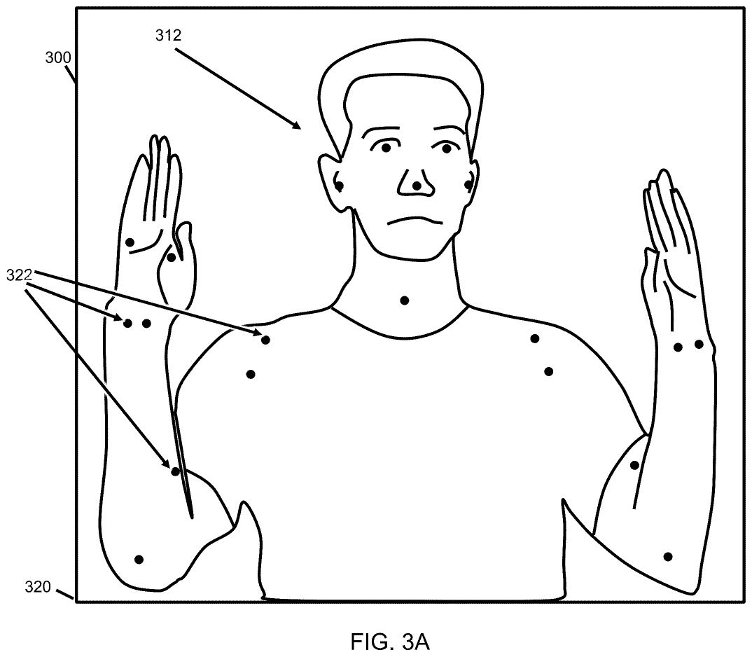

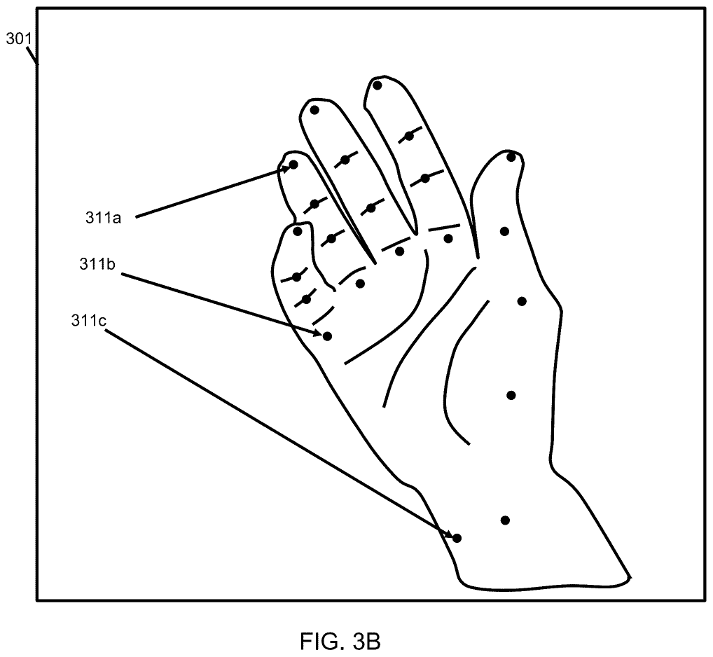

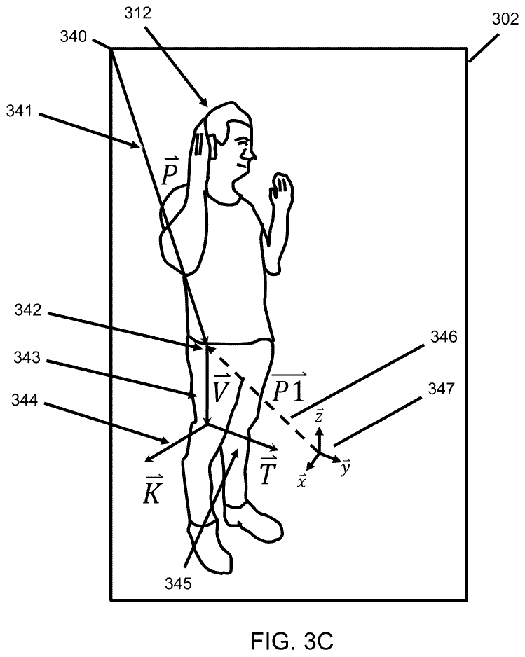

FIG. 3A illustrates, by way of illustrative example, an image frame 300 including an upper portion of a human subject 312 in a particular pose. Initial 2D salient point representations 322 are shown at a variety of anatomical locations. As mentioned above, for a given image frame, the initial 2D salient point representations can be determined by the representation generation module, for example including an AI or ML component trained on manually annotated data, an AI/ML components trained as described herein, or by another suitable method. The initial 2D representations of salient points 322 of FIG. 3A may be expressed in two dimensions, for example as a pair of coordinates indicating horizontal and vertical distance, respectively, from the lower left corner 320 of the image frame 300. Some or all initial 2D representations of salient points 322 may, although not necessarily (e.g., depending on the configuration of the representation generation module with respect to generating initial representations), represent bony landmarks or joints, or other landmarks such as a center of an iris or a fingertip, that have anatomical meaning, or a corresponding reference location, on a human skeleton. Initial 2D representations of salient points may be indicated on the image frame as corresponding single pixels or corresponding sets of pixels comprising the image frame, each corresponding to the associated salient point for the subject.

FIG. 3B illustrates, by way of illustrative example, an image frame (or portion thereof) 301 including a wrist and hand of the human subject 312 in a particular pose. Initial 2D representations of salient points are shown at a variety of anatomical locations, such as initial 2D salient point representation A 311a corresponding to the fingertip of the ring finger of the right hand, initial 2D salient point representation B 311b corresponding to the metacarpophalangeal joint of the fifth phalanx of the right hand, and initial 2D salient point representation C 311c corresponding to the head of ulna of the right hand.

In some embodiments, initial representations of the physical subject may be or may include initial vector representations of the physical subject. A vector representation, whether initial, enhanced, or inherently constrained, may include one or more vectors. Vectors may be indicative of locations of salient points for the human subject in relation to another vector or a reference point. Vectors may be representative of locations, lengths and/or (2D or 3D) orientations of rigid bodies for a model of the human subject. Some vectors may be orientational and used for specifying an orientation of a rigid body. Vectors may be 2D or 3D vectors and may be expressed with respect to a movable (e.g., center of pelvis that changes location/position corresponding with the change in pose of the physical subject between two or more image frame sets) or a fixed reference point or frame (e.g., selected origin, such as an arbitrary fixed point, a fixed landmark in the image frame sets such as a tree, stop sign or a point on a soccer field such as a goalpost, etc.), and with respect to a local (e.g., 2D camera image frame) or global reference point (e.g., selected 2D or 3D origin). Vectors may be higher-dimensional (e.g. six to nine or more dimensions). A single such vector may indicate, for example, position and orientation of a body in two-dimensional or three-dimensional space. For example, some components of the vector may represent position while other represent orientation.

FIG. 3C illustrates, by way of illustrative example, an image frame 302 including the human subject 312 in the particular pose. The image frame 302 has identified or annotated thereon an initial (2D) vector representation [symbol] 341 indicative of the location of a hip salient point 342 (e.g., center of right hip joint) relative to the upper left corner 340 of the image frame 302 which is selected in this example as a reference point. A reference point may be suitably selected in 2D with respect to a part of the image frame, and in 3D with respect to a model of the subject, for example. An example reference point 347 is shown. For example, in 2D, another initial (2D) vector representation [symbol] 346 may be indicative of the location of the same hip salient point 342 (e.g., [x, y, z] center of right hip joint) relative to the reference frame 347, as shown. Enhanced vector representations obtained from a model of the subject, and inherently constrained vector representations generated by an enhanced AI module can be visually represented similarly to the initial vector representations illustrated in the non-limiting example of FIG. 3C.

Vector representations of salient points may be similarly indicated using 2D vectors in relation to a reference frame.

In cases where an enhanced vector representation is indicative of a part or a rigid body according to the model of the subject, one vector may be used to indicate the rigid body location and length. For example, with reference to FIG. 3C, supposing the vector representation [symbol] 343 is an enhanced vector representation, it may be indicative of a rigid body that corresponds to a right femur bone of the subject 312. Such enhanced vector representation [symbol] 343 may be indicated by a first vector, such as vector [symbol] 346, the terminal end of which is used to indicate the location of the initial point of the enhanced vector representation [symbol] 343 in the image frame, and the enhanced vector representation [symbol] 343 further indicating location/direction and length of the rigid body.

In some cases, another vector may be required to indicate orientation of the rigid body that is represented using a vector. For example, in 3D, a vector normal to such supposed enhanced vector representation \vec{V} 343 may be used to indicate orientation thereof and may be included in the (e.g., data representative of) the enhanced vector representation [symbol] 343 of the corresponding rigid body. In another example, another vector, such as vector [symbol] 344 indicative of direction from the medial meniscus to the lateral meniscus of the right knee. Notably, the vector [symbol] 344 can itself be or be a part of an enhanced vector representation of another rigid body indicative of, for example, the the medial meniscus and the lateral meniscus of the right knee.

Therefore, more generally, in a non-limiting example, each vector representation may include a vector that is aligned with or along the rigid body, a part or a salient point it represents, or may include vectors originating at a same reference point and terminating one at the initial point of the vector representation and the other at the terminal point of the vector representation. For example, a vector [symbol] 345 may be defined as across product of two vectors [symbol] 344× [symbol] 343. In another non-limiting example, a vector

$$\vec{W} = [ \begin{matrix}\vec{P} \\ \vec{V}\end{matrix} ]$$

may be defined as a combination of vector [symbol] defining the initial end of vector [symbol] and vector [symbol] defining the rigid body, salient point or part length and location. Further adding [symbol] or [symbol] to [symbol] would also allow [symbol] to specify rotation of the (e.g., right femur) rigid body in 3D.

In embodiments, any number of 2D or 3D vectors can be combined (such as [symbol] , [symbol] , [symbol] , [symbol] ) as needed to indicate 2D or 3D vector representations. Initial 2D vector representations can be combined, similarly to combining of initial 2D salient point representations to generate a 3D point cloud as discussed elsewhere herein, to obtain initial 3D vector representations of the subject. By using multiple cameras to obtain respective image frames of the subject from different angles, initial 2D vector representations from these different views can be combined to generate initial 3D vector representations of the subject, where at least some of the initial 3D vector representations represent, for example a probabilistic or best fit 3D locations according to the corresponding one or more 2D locations of the corresponding initial 2D vector representations.

In embodiments, the examples and characteristics of vector representations described above are applicable to initial, enhanced and inherently constrained vector representations. For an illustrative example, although FIG. 3C shows non-limiting example of initial vector representations identified or annotated onto the image frame, enhanced vector representations obtained from the model of the physical subject can be appear similarly when overlayed, using backprojection as described elsewhere herein, onto the image frame to obtain an output image that can be an output or used to obtain an output in an of itself, or be part of an enhanced training data, for example. A trained enhanced AI module can be configured to output inherently constrained vector representations that can be, in a non-limiting example, visually represented similar to FIG. 3C.

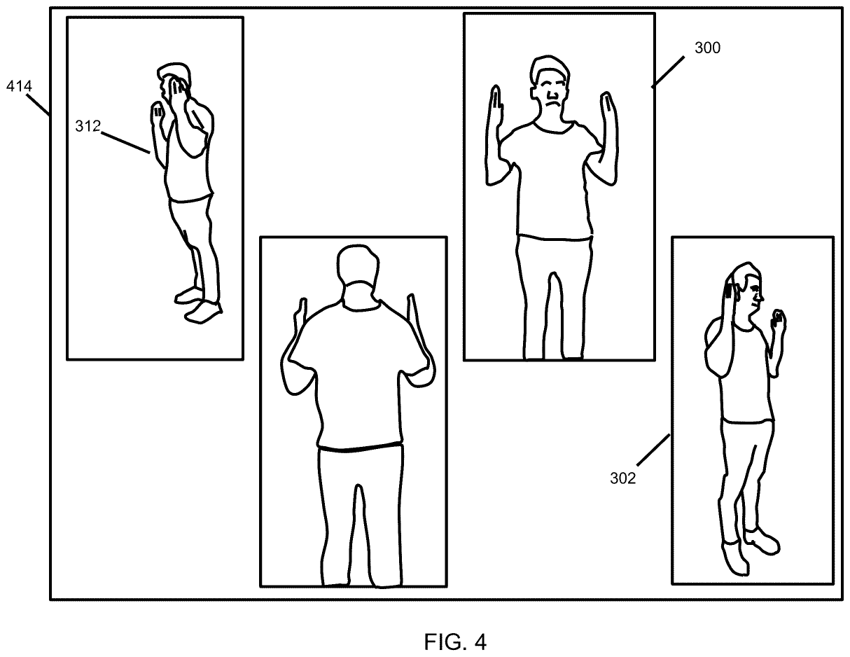

FIG. 4 illustrates an image frame set 414 including the human subject 312 of FIG. 3A. Each image frame of the set 414 is taken at a substantially same time as the other image frames of the set (i.e., synchronized), by a different camera at a different respective physical (or virtual) location, pointed in a different respective direction, or a combination thereof. The cameras may be arrayed to partially or fully surround the subject. Multiple subjects may be present within the cameras' fields of view, and these subjects can be automatically (e.g., by correspondingly configuring the representation generation module) or manually individuated prior to further processing.

Each image frame set thus includes multiple image frames. Each image frame of a same image frame set indicates a (real or virtual) camera image of the subject, at a same time and from a different respective angle corresponding to the location of the corresponding camera. Multiple such image frame sets can be obtained, where each image frame set corresponds to a different point in time, for example as generated according to video camera data showing motion via sequence of successive frames. The image frame sets used herein at least for parametrizing the model of the physical subject and in subsequent training of the enhanced AI module, are also referred to herein as “training camera images frame sets” for clarity. The term “images frame sets” as used herein can apply more generally to any image frame sets that, for example, may be a part of camera data from one or more real or virtual cameras used at least in part as input by the enhanced AI module to generate inherently constrained representations and output motion or still image capture data and in such particular example not necessarily used in model parametrization and training. In other words, herein an “image frame set” may, although not necessarily, be a “training camera image frame set”.

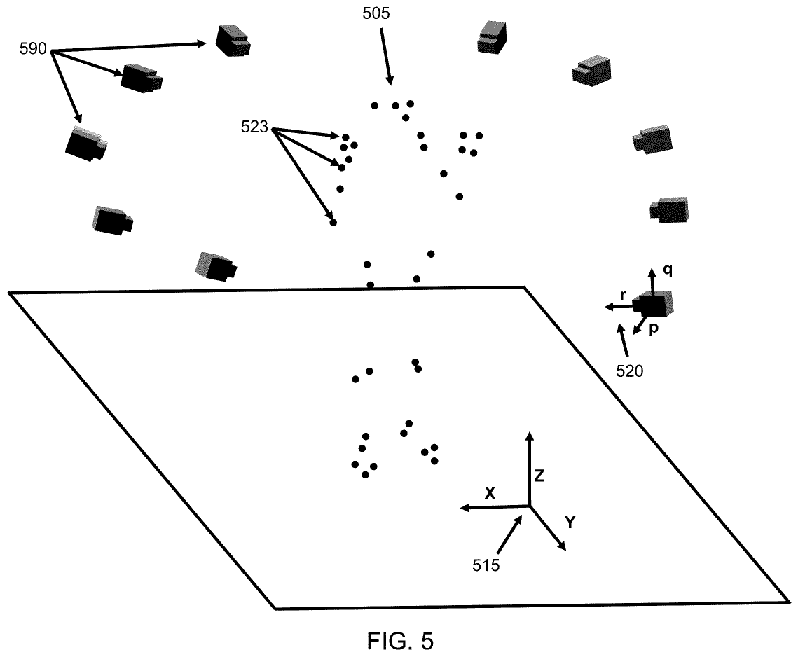

FIG. 5 illustrates a diagram showing locations and orientations of the multiple (i.e., two or more) cameras 590 providing the image frame set of FIG. 4, along with a 3D point cloud 505 of initial 3D salient point representations 523 generated for the human subject 312 of FIG. 3A based on initial 2D salient representations 322 some of which are shown in FIG. 3A. The locations and orientations of cameras are shown with respect to a global three-dimensional coordinate system having the reference point (origin) 515 that includes a set of x, y and z axes. The multiple cameras 590 are part of a multi-camera setup, which is calibrated. The calibration involves determining (e.g., computing, estimating, measuring) and registering the positions, angles and fields of view of the various cameras 590. Each camera 590 also defines, due to its position and orientation, its own respective local reference point 520 that includes a respective set of p, q and r axes originating at the camera's location. Notably, a given initial 2D salient point representation can be expressed in terms of the global coordinate system using x, y and z axes of the global reference point 515 or in terms of any one of the local coordinate systems using respective p, q and r axes of the corresponding local reference points 520. One or more initial 2D salient point representations can be combined (e.g., based on probability, best fit, etc.) to obtain a corresponding initial 3D salient point representation 523. A point expressed in one coordinate system can be re-expressed in another coordinate system via a (typically) linear transformation. For example, a particular initial salient point representation in a particular image frame can be first identified as and represented in 2D as a (p, q) point (e.g., pixel) on the image frame and have a corresponding distance between the initial salient point and the camera or a reference location on the subject, as described elsewhere herein. Where this distance can be indicated along the r-axis of the corresponding camera, the initial 3D (p, q, r) representation of the salient point may be obtained based on its 2D (p, q) representation. Subsequently, the global 3D (x, y, z) initial salient point representation may be obtained using relative positions of all corresponding cameras.

Furthermore, each salient point may be identified within the field of view of at least one of the cameras 590 and corresponding initial 2D representation of the salient point may be generated for respective image frame of each of the at least one such cameras and used to generate a corresponding initial 3D salient point representation. Notably, not all cameras 590 can necessarily be used in generating all the initial salient point representations since respective fields of view of some cameras may show only a portion of the human subject 312, and therefore do not “see” all of the possible salient points, e.g. as seen in the image frames of the set 414 of FIG. 4. Combining all 2D representations for a same salient point can result in a group of individual initial 3D representations which can be represented as a 3D bubble or sphere corresponding to the identified location area of the salient point representation in 3D. Given the location of the initial salient point representation within each camera's field of view, and the locations and orientations of the cameras, the location of the initial 3D salient point representation within the global three-dimensional coordinate system can be determined using triangulation or similar operation. When three or more cameras show the same initial salient point representation, a “best fit” (e.g., probabilistic) location for the initial 3D representation of the initial salient point can be determined, for example using a least-squares estimation approach. Each initial salient point representation can be treated in this way. Accordingly, the locations of multiple initial 3D salient point representations in the global three-dimensional coordinate system can be determined based on initial 2D salient point representations and synchronized and calibrated camera data from multiple cameras.

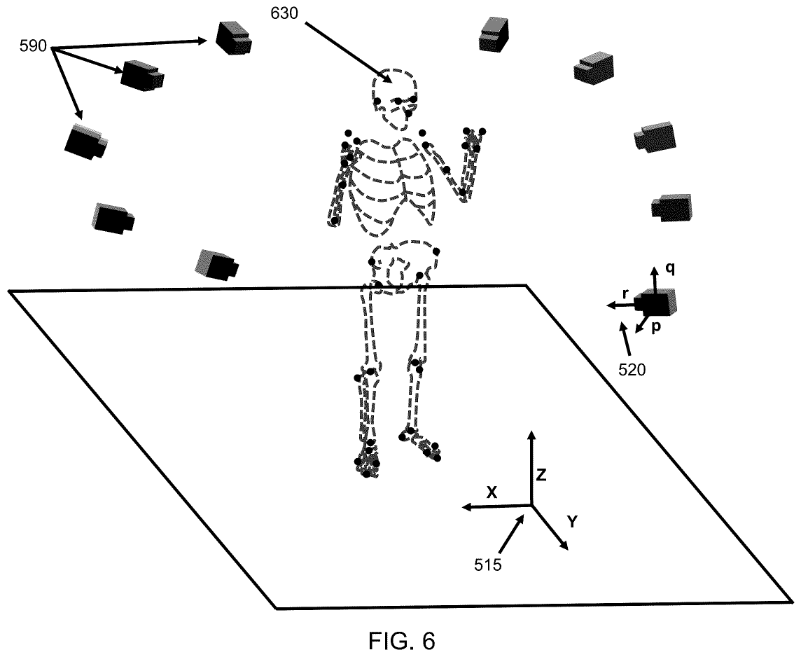

FIG. 6 illustrates a generated (articulated) model 630, in this case a human skeletal model, for the human subject 312, parametrized according to the initial 2D salient point representations 322 of FIG. 3A and/or subsequently generated initial 3D salient point representations 523 of FIG. 5, possibly along with similar initial 2D salient point representations obtained from other image frames not shown, in addition to the image frames of the set 414 of FIG. 4, in the same time sequence as the image frame set (i.e. showing the same physical subject in the same pose).

In embodiments, an articulated model may include a set of rigid bodies such as bones, which are interconnected with one another in a predetermined manner. The articulated model represents and incorporates at least some of the physical constraints for the subject. The parameters may include the sizes (e.g., lengths), locations, orientations and/or dimensions of each rigid body (e.g., bone), and the articulated model may be parametrized (e.g., scaled, positioned) according to such parameters, for example. The articulated model is correspondingly generated to match or correspond with the pose of the physical subject, as appearing in one or more training camera image frame sets, such as set 414 of FIG. 4, at least in part by configuring sizes, locations and orientations of the two or more rigid bodies. The parameters may include the three-dimensional position and orientation of each rigid body of two or more rigid bodies of the model relative to another one or more rigid body, or relative to a selected reference point. Thus, the parameters may be used to parametrize the dimensions, position, orientation, pose, or a combination thereof of the articulated model. The parametrization may be subject to various physical constraints, such as kinematic or dynamic constraints that the model incorporates (e.g., according to the template model), as described elsewhere herein.

Also shown in FIG. 6 are the cameras 590 and the global x, y, and z axes of the global reference point 515 and p, q, and r camera axes of respective local reference points 520. The articulated model may be overlaid over the 3D point cloud 505 of initial 3D salient point representations 523 so that the articulated model 630 at least approximately (e.g., best fit) aligns with the 3D point cloud 505. The initial representation are, therefore used as a guide in generating the model to match the (e.g., pose, size, orientation, etc., of the) physical subject. However, as discussed elsewhere herein, there may be significant differences between the initial (3D or 2D) salient point representations and corresponding locations (i.e., enhanced 3D or 2D representations) on the articulated model 630, at least in part highlighting the improved accuracy and consistency of enhanced representations compared to the initial representations that are not constrained according to the model that incorporates physical constraints as disclosed herein. The articulated model 630 can be defined or generated for a plurality of time instances, each having a different pose corresponding for example to the initial salient point representations of a different image frame set.

The articulated model 630 can be used as the basis for defining, identifying or generating enhanced representations for the physical subject or a portion thereof. For example, each rigid body, part and/or point in the articulated model can define, at one or more positions on the rigid body, part and/or point, an enhanced representation with a particular label. The position may be a position which is defined relative to the rigid body, part and/or point, regardless of the rigid body's, part's and/or point's size or orientation, such as a global position relative to a global reference point. The label may have an anatomical meaning, such as a named or unnamed anatomical part of a bone. Accordingly, based on an articulated model in a given location, orientation and pose, and with a given size of each of the articulated model's rigid bodies, parts and/or points, the location in three-dimensional space of each of these defined enhanced 3D representations can be defined. These newly defined enhanced 3D representations or data indicative or representative thereof can be used to generate or be included in the enhanced training data.

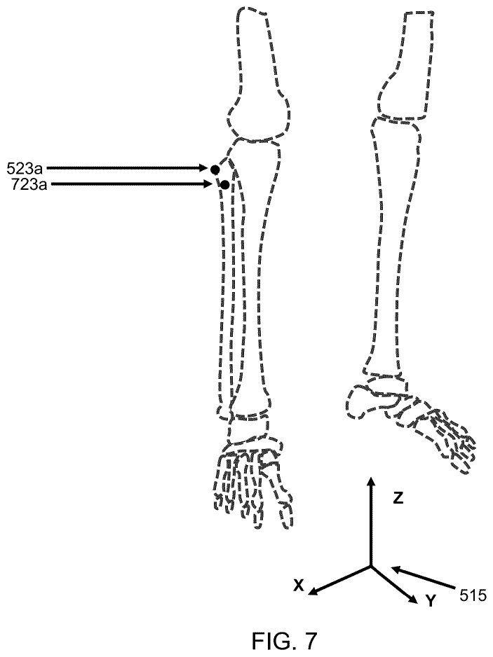

FIG. 7 illustrates a portion of the articulated model 630 of FIG. 6. In particular, the position of a generated initial 3D salient point representation 523a (e.g., from the representation generation module) is shown, along with the position or location of a corresponding subsequently identified enhanced 3D salient point representation 723a (e.g., from the model-based module) having the same label (head of fibula or HF), but having a slightly different location, as shown. The subsequently identified enhanced 3D salient point representation 723a, as defined according to the generated articulated model, may be considered preferable and potentially more accurate as a result of physical constraints incorporated into the articulated model 630, or at least more consistent with other such enhanced salient point representations as generated from the same articulated model.

For example, the identified initial representations of salient points may have been identified on 2D image frames by the representation generation module which, for example, has been trained using two-dimensional images which have been at least in part manually annotated with the locations and labels of initial salient point representations. A large number of such images would be used in initial training of such representation generation module, with individuals defining anatomical landmarks on the image by hand, using their best approximation of that location. This process can be repeated many times and the representation generation module, as a result, can learn to identify the initial 2D salient point representations on 2D image frames substantially automatically (i.e., without further manual annotation). However, due for example to limitations in manually annotating images used in such training, these initial 2D salient point representations may not be physically consistent (e.g., may have a 3D representation that is a probabilistic estimate based on initial 2D salient point representations of a same salient point from different image frames of the image frame set, from different frame sets, or a combination thereof) and are difficult to locate. Furthermore, if fewer cameras are used in generating the initial representations, the positions of such initial representations may be less accurate since fewer camera views are available to obtain, and subsequently approximate the location of, e.g., a salient point using its initial 3D representation. The representation generation module trained to substantially automatically identify the initial salient point, vector, position, orientation and/or pose representations, having been trained using manually annotated images, is therefore inherently prone to at least similar limitations.

To further illustrate, consider a person who is manually identifying a series of image frames of the same subject walking across a room. If they are tasked to identify the hip and knee joint in each image, then the distance between these points would be different in each frame because of errors associated with the manual process. Since the bones of a human skeleton are obscured by muscles, tissues, clothing, etc., and are therefore not seen in the image frames, manually annotated images, or similarly annotated e.g. using a motion capture suit, may at most be mere estimates of anatomical points and locations thereof. Accordingly, if the manually or similarly annotated initial representations are used for (initial) training of the representation generation module, and hence the initial representation identified by the (initially trained) representation generation module trained thereon, likely will not satisfy at least some of the physical constraints that the physical subject imposes (e.g. the thigh is rigid).

Accordingly, embodiments of the present invention aim to avoid or improve upon the use of (e.g., AI/ML) modules trained solely using such manually annotated data, to improve accuracy. By using enhanced representations which are constrained having been generated from the model that incorporates physical constraints, the enhanced training data may be generated which is has improved consistency across image frames and image frame sets, and which obeys or follows appropriate physical constraints and is consistent in 3D even when having been presented (e.g., using backprojection) in 2D image frames. The resulting trained enhanced AI module is also expected to generate inherently constrained representations that inherently obey or follow such physical constraints and exhibit the same type of consistency, even when generated using camera data that includes 2D image frame sets from only a single camera. For example, the inherently constrained representations generated using the enhanced AI module trained using such enhanced training data, will have inherent kinematic, dynamic, or both, consistency, e.g. in terms of constant lengths of rigid bodies and joint movements limited to predetermined ranges, and inherent dynamic consistency, e.g. in terms of respecting inherently defined laws of physics with respect to movement of the subject and parts thereof, even without such constraints and consistencies being explicitly applied or imposed during the generation of the inherently constrained representations. The consistency may persist across a time sequence of image frame sets representing a motion over time.

Accordingly, the model-based module 130 may be used to generate, based on the initial representations, the articulated model or at least indications of the articulated model, from which the enhanced representations can be obtained. The generated indications may be represented, for example as real or artificial images, although the indications may be or may include pure data, such as values of the model-based module defining dimensions, position, orientation and pose. That is, the model-based module 130 may generate indications/images of the model (e.g. indicating and including the model in respective poses and/or from respective angles or points of view). A set of such indications/images that are sequential may be representative of a movement of a subject over time. Having been obtained from the model, the indications/images will satisfy the physical constraints, such as kinematic and dynamic constraints, that govern motion for the physical subject.

In an example embodiment, the model-based module can be used to define enhanced 3D representations of salient points on the articulated model as follows. As noted above, each rigid body (e.g. bone) of the articulated model can take on a defined size, location and orientation according to parametrization of the articulated model based on the initial representations. A template for each rigid body of a template model for the subject type can thus be parametrized (e.g., resized, scaled and repositioned (translated, rotated)) according to the parameters. The templates for each rigid body can, in addition to the overall template model, incorporate physical constraints specific to the rigid body. Following the generation of the model that includes parametrization thereof, one or more enhanced 3D representations of salient points, e.g. representing points of anatomical meaning such as head of the fibula (HF), can be obtained from the model (e.g., as data indicative of enhanced representations) and/or Indicated on the model (e.g., indicated skeleton having a corresponding pose, indicated enhanced salient point representations, e.g. as shows in FIGS. 6-7). The location of these enhanced 3D representations can also vary with resizing and repositioning of the model according to a particular pose and/or viewing angle. The enhanced representations of salient points can be indicative of locations on the model that correspond to physical locations on the physical subject. Such locations on the model can be 3D spatial coordinates. Thus, the model-based module can also output (indications of) enhanced 3D (salient point, vector, pose, or a combination thereof) representations which are in fixed/consistent/constrained positions relative to the parts or rigid bodies of the articulated model and which thus take on definite positions corresponding to definite parameters (indicating position, orientation, pose) of the articulated model. The enhanced 3D representations will therefore be consistent over time for a given physical subject, as aspects such as size will be fixed by the physical constraints.

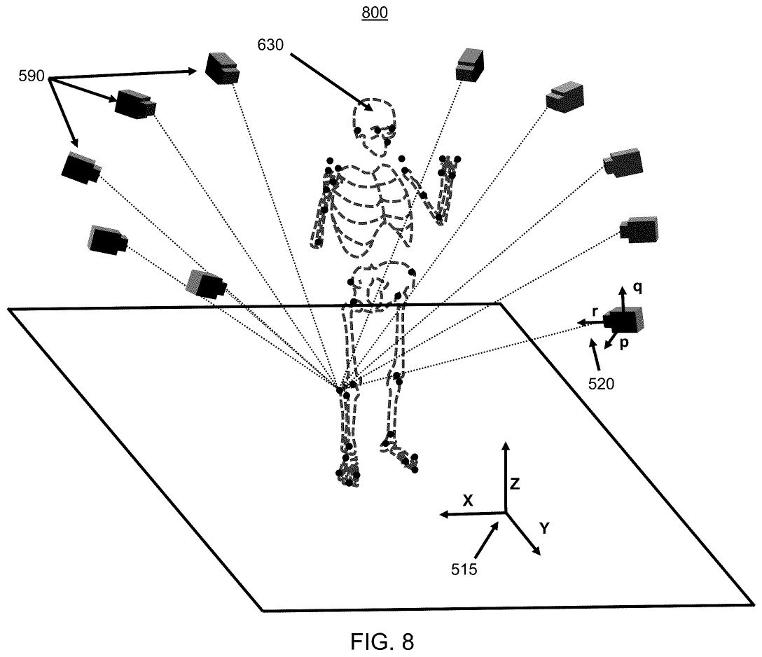

FIG. 8 schematically illustrates a reverse triangulation/backprojection operation 800 (also referred to herein as backprojection, projection), by which enhanced 3D representations, such as the illustrated enhanced 3D salient point representation 723a, as defined by the model-based module, are projected onto corresponding real or virtual camera image frames of respective cameras 510 (i.e., same corresponding image frames that were used to obtain initial 2D salient point representations and subsequent initial 3D representations). This projection involves determining (e.g., by reverse triangulation, using original camera data) the 2D location of the enhanced salient point representation within the frame of each such camera image frame from the corresponding enhanced 3D representation (e.g., 723a). Notably, this enhanced 3D salient point representation (e.g., 723a), projected onto a camera image frame, will be also constrained according to the physical constraints used for defining the model of the subject. Where the physical constraints include consistency constraints across image frames, these physical constraints may apply to an entire sequence of image frames rather than just a single frame. Furthermore, despite each camera image frame being two dimensional, the enhanced representations are consistent in three dimensions at least in part as a result of having been projected from the model that is physically consistent and constrained in 3D. The output of this projection is enhanced training data that includes indications (e.g., data, spatial coordinates, labels, enhanced representations overlayed onto real or artificially generated image frames) of enhanced salient point, vector, position, orientation and/or pose, or combination thereof, representations. The output of this projection, which may be performed by the model-based module, the training data generation module, or another module, or a combination thereof, can be provided to the AI training module and for training to obtain the enhanced AI module. The entire image of the model (e.g. the entire skeleton or an artificial image of a subject built around the skeleton) of the physical subject as well as the enhanced 3D salient point, vector, position, orientation and/or pose, or combination thereof, representations can be backprojected to define enhanced 2D salient point, vector, position, orientation and/or pose, or combination thereof, representations that can be combined with (e.g., overlayed onto) the corresponding image frames, and, together with the image frames, can be used as annotated images of the enhanced training data for use in training of the enhanced AI module. Moreover, where the output of the model-based module is three-dimensional, the output can also be used to define an indication of distance from the real or virtual camera lens of the corresponding real or virtual camera, onto which the output is being backprojected. Therefore, additionally or alternatively to defining the two-dimensional locations of enhanced 2D representations within a camera image frame through backprojection, the enhanced 3D representations may be used to define indications of distance therefrom to respective cameras. These indications of distance may be used as part of enhanced training data.

In a non-limiting example, for at least one enhanced 3D salient point representation as provided for example by the model-based module 130, and for each of a set of one, two, or more real or virtual cameras, a backprojection operation can proceed as follows. The enhanced 3D salient point representation may be assumed to be a three-dimensional coordinate within a global coordinate system. Based on angle, field of view dimensions and location information for the camera, a position for the enhanced 2D salient point representation within the camera field of view is determined for some or all image frames. This position is the position at which the salient point of the physical subject would register to the camera, if the point were visible to the camera with the point being located at its three-dimensional coordinate. The term “register to the camera” may be taken for example to mean that the camera would, if observing (i.e. having its optical sensors exposed to) such a salient point (e.g., 105 of FIG. 1B), produce the enhanced 2D representation (e.g., 112a of FIG. 1B) of the salient point at this position within the camera's output representing a two-dimensional image. Then, the enhanced training data includes this position within the camera field of view. The training data can include this position within the camera field of view for each of the one, two or more real or virtual cameras.

It is noted that the operation of FIG. 8 can, in reverse, be performed to identify the location of initial 3D salient point representations in a three-dimensional global coordinate system based on the locations of the initial 2D salient point representations in the respective coordinate systems of camera images.

FIG. 9 illustrates a combination (e.g., an overlay) of an enhanced pose representation 631 (i.e., appears as the skeleton in the figure) and a plurality of enhanced salient point representations 723 obtained from the generated articulated model 630 of FIG. 6 with the image frame 303 of the training camera image frame set 414 of FIG. 4 that includes the human subject 312. The enhanced pose representation 631 is representative of and matches the same pose of the subject 312 as seen or identified in the image frame set 414 from a particular view of the corresponding camera used to obtain the image frame 303. The enhanced pose representation 631 in FIG. 9 is two-dimensional and shows the enhanced 2D pose representation of the subject as if captured by the corresponding camera used to obtain the image frame 303 onto which the enhanced pose representation 631 is overlayed. Similarly, enhanced salient point representations 723 are illustrated. Such an overlayed image may be included in the enhanced training data and may be obtained via backprojection (reverse triangulation), for example by projecting the articulated model 630 of the subject 312 having the same pose as in the image frame set 414 and from an angle or point of view of the corresponding camera onto one or more of the image frames, such as the image frame 303, of the set 414. The enhanced pose representation (skeleton) and the enhanced salient point representations is combined with a corresponding camera image frame to obtain respective output image indicative of the respective enhanced representations from a point of view of the camera in a pose that matches the pose of the subject in the corresponding image frame. Each salient point representation can be generated, at least in part by determining, for each camera belonging to a set of one or more real or virtual cameras and configured to provide training camera data, a position, within an output image of the camera, or within an artificially generated image, at which the enhanced representation of the salient point would be indicated by the camera as if a corresponding salient point were visible to the camera. Such the position can be determined based on an angle, a field of view dimensions and a location information for the camera. Additionally or alternatively, each salient point representation can be generated, at least in part by determining a distance from the salient point to the camera. Such distance can be based on at least the location information for the camera. For each camera, one or both of: the position at which the enhanced representation of the salient point would be indicated by the camera; and the distance from the corresponding salient point to the camera, can be included in the enhanced training data. The enhanced training data can further include the output images showing the model (i.e., enhanced pose representation generated therefrom), from the point of view of the corresponding camera. FIG. 9 represents, on the one hand, a three-dimensional scene including a three-dimensional skeleton model and its associated representations. But, notably, FIG. 9 is also a two-dimensional drawing and can thus be viewed as also representing a projection of this scene onto a two-dimensional camera image, where the camera image coincides with the drawing page.

Enhanced representations can be correlated with an output image (e.g. a real or artificial image of a subject) for example by being provided along with but separate from the image, for example as a list of coordinates or values indicating locations or vectors in the image. Enhanced representations can be represented on the output image, for example as features (e.g. included points or vectors) within the image itself.

The resulting enhanced training data, as shown in the example of FIG. 4 can include, for example, a (p 825, q 826) 2D coordinate of the enhanced 2D salient point representation 723b (which is obtained from the corresponding enhanced 3D salient point representation 723a of FIG. 7) and distance (not shown, going outward and normal to the shown image frame) from the enhanced 2D salient point representation 723b and may include other information, such as a label (e.g., HF), as discussed elsewhere herein.

In embodiments, the enhanced AI module trained using the enhanced training data may be used for motion (or still image) capture of a 2D camera video feed, obtained using one or more real or virtual cameras, and comprising one or more sets of image frames indicative of one or more physical subjects, to generate motion or still image capture data that can include inherently constrained representations, for at least some of the one or more (e.g., sequential) image frame sets of the set. Such motion or still image capture data is inherently constrained due to usage of the model in obtaining of the enhanced training data that was under in training of the enhanced AI module. The set(s) of image frames can be provided as a part of camera data received, for example, by an input module correspondingly configured. The inherently constrained representations can include one or more inherently constrained representations of salient points for the physical subject, one or more inherently constrained vector representations for the physical subject, one or more inherently constrained pose representations of a pose of the physical subject in the one or more camera image frame sets, an inherently constrained three-dimensional computerized representation of the physical subject (e.g., a 3D model of the subject similar to the articulated model although having been generated without explicit incorporation of physical constraints and parametrization, e.g. an avatar), or a combination thereof.

In some embodiments, the inherently constrained representations may be overlayed onto a video feed). In some cases, given sufficient (e.g., computational) resources, such overlaying may be done substantially in real time as the video is being produced by a camera. Advantageously, the enhanced AI module trained using the enhanced training data can generate or output one or more type of inherently constrained representation (i.e., salient point, vector, pose, 3D model) for respective one or more subjects for sequential sets of image frames from a single camera. In other words, once trained, the enhanced AI module can operate with improved accuracy as described herein without requiring backprojection, and outputting motion or still image capture data that in inherently constrained despite having been generated from camera data of a single camera, although more than one camera may be used.

In embodiments, the physical subject, as referred to herein, may be a whole physical subject, or may be a portion of the physical subject (e.g., a hand). One or more module described herein, such as the representation generation module, (e.g., enhanced) AI module, processing module, or a combination thereof, may be configured to generate representations for a selected one or more portion of the physical subject. Such configuring may advantageously limit the (e.g., computing) resources associated with or needed for generating of the salient points and any subsequent processing (e.g., generating of initial 3D representations of salient points, generating of the articulated model, generating of the enhanced 3D representations of salient points, backprojection, etc.).

It should be noted that image frames or portions thereof illustrated in FIGS. 3A, 3B, 3C, 4, and 9 are shown schematically for ease of illustration. Embodiments disclosed herein are similarly applicable to photographic real or virtual images frames and image frames obtained from a real or virtual video.

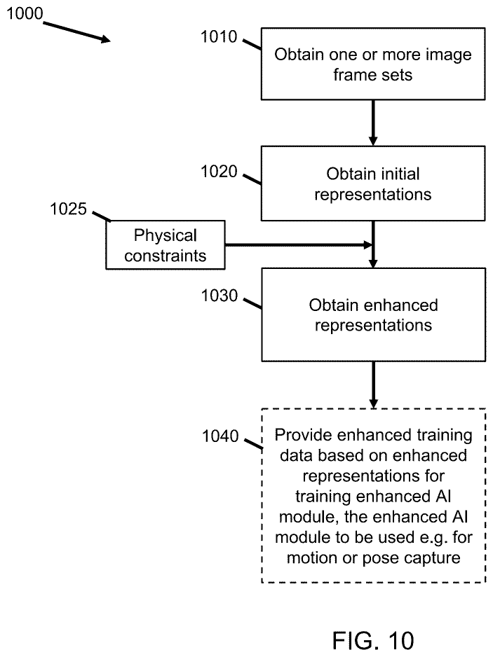

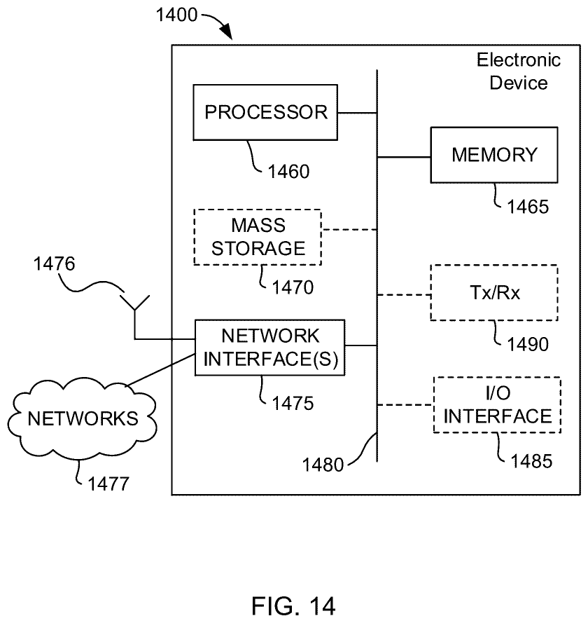

FIG. 10 illustrates a procedure or method 1000 provided according to embodiments of the present invention. The procedure or method can be carried out by part or all of the system of FIG. 1A or FIG. 2 implemented using a computing apparatus, such as an electronic device describe elsewhere herein with reference to FIG. 14, in association with appropriate video cameras or input interfaces and output interfaces. Embodiments of the present invention provide for the entire method or a portion thereof, particularly the portion pertaining to the obtaining of enhanced representations. Here and elsewhere, where appropriate, the action of generating certain data may be replaced with the action of obtaining that data, for example from another device which generates the data. Furthermore, “obtaining” data may include “generating” that data.

The method 1000 includes step 1010 of obtaining one or more image frame sets that include one or more physical subject. The method 1000 includes step 1020 of generating (one or more) initial representations for at least one of the one or more physical subjects using the camera data that includes the image frames of the image frame sets obtained using one or more real or virtual cameras. The method 1000 includes step 1030 of generating enhanced representations based on the initial representations and in accordance with physical constraints 1025. The method 1000 may include step 1040 of providing an enhanced training data, obtained or generated based on the enhanced representations, for training of an enhanced AI module to generate inherently constrained representations.

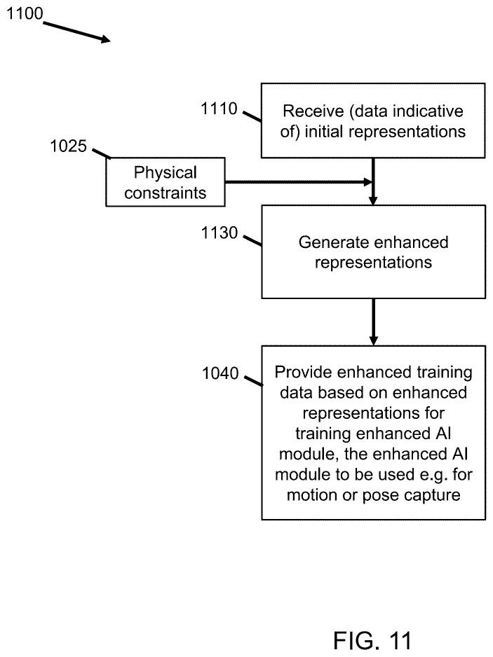

FIG. 11 illustrates a procedure or method 1100 provided according to embodiments of the present invention. The procedure or method can be carried out by part or all of the system of FIG. 1A or FIG. 2, for example, implemented using a computing apparatus, such as an electronic device describe elsewhere herein with reference to FIG. 14, in association with appropriate video cameras or input interfaces and output interfaces. Embodiments of the present invention provide for the entire method or a portion thereof, particularly the portion pertaining to, by a system comprising one or more modules, generating of enhanced representations and providing of enhanced training data.

The method 1100 includes step 1110 of receiving data indicative of initial representations for at least one physical subject of a one or more physical subject of the one or more image frame sets, the initial representations generated using the one or more image frame sets that include the one or more physical subject. The method 1100 includes step 1130 of generating enhanced representations based on the received data indicative of initial representations and in accordance with physical constraints 1025. The method 1100 includes step 1040 of providing an enhanced training data, obtained or generated based on the enhanced representations, for training of an enhanced AI module to generate inherently constrained representations.

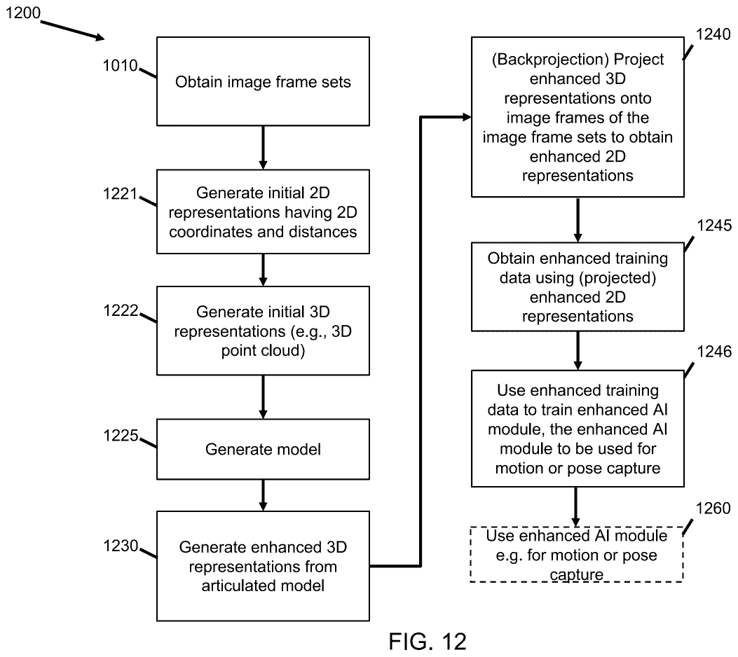

FIG. 12 illustrates an example procedure or method 1200 provided according to embodiments of the present invention. The procedure or method can be carried out by part or all of the system of FIG. 1A or FIG. 2, for example, implemented using a computing apparatus, such as an electronic device describe elsewhere herein with reference to FIG. 14, in association with appropriate video cameras or input interfaces and output interfaces. Embodiments of the present invention provide for the entire method or a portion thereof, particularly the portion pertaining to the generating of the model based on the initial representations, the generating of enhanced representations and providing of enhanced training data.

The method 1200 includes step 1010 of obtaining one or more image frame sets that include one or more physical subject. The method 1200 includes step 1221 of generating (one or more) initial 2D representations for at least one of the one or more physical subject using the camera data that includes the images of the image frame sets. Where at least some of the initial 2D representations are initial 2D salient point representations, each of such generated initial 2D salient point representations, or respective data indicative or representative thereof, includes respective first spatial coordinate that is a 2D spatial coordinate of the corresponding initial 2D salient point representation, and a distance, such as a distance from the 2D spatial coordinate (p, q) to the respective camera. The distance may be a representation of an additional coordinate (r).

The method 1200 includes step 1222 of generating respective initial 3D representations based on camera data that includes the (data indicative of) initial 2D representations generated at step 1221. The method 1200 includes step 1225 of generating a model of the physical subject based on the initial 3D representations generated at step 1222 and using the model template for the physical subject type, the model having incorporated therein physical constraints for the physical subject type and parametrized based on the initial 2D, 3D, or both, representations for the physical subject.

The method 1200 includes step 1230 of generating enhanced 3D representations from the articulated model. The step 1230 may include, for example, identifying, annotating, noting and/or indicating the enhanced 3D salient point, vector, position, orientation and/or pose representations on the articulated model (e.g., identified enhanced 3D representation 723a of the corresponding enhanced salient point of FIG. 7). The step 1230 may include generating data indicative or representative of the enhanced 3D representations of salient points.

The method 1200 includes step 1240 of backprojection that includes projecting the generated enhanced 3D representations onto corresponding (2D) image frames of the image frame set. Such projecting at least in part enables generation or obtaining of enhanced 2D representations and, where at least some of the enhanced representations are enhanced 2D salient point representations, determining respective spatial coordinates (e.g., enhanced (p, q) coordinates). Backprojection step 1240 may also include backprojecting the generated articulated model in a pose matching to the camera images onto the images of the image frame sets to obtain images similar to FIG. 9 that can also be included in the enhanced training data as example training images. For example, a skeleton model can be texturized (e.g. with muscle and skin layers) to generate an image which is projected onto camera image planes and used as AI training data.

The method 1200 includes step 1245 of obtaining an enhanced training data using the (projected) enhanced 2D representations, for training of an enhanced AI module to identify inherently constrained representations. The trained enhanced AI module may be used at step 1260 for motion (or still image) capture, or for generation of other data.

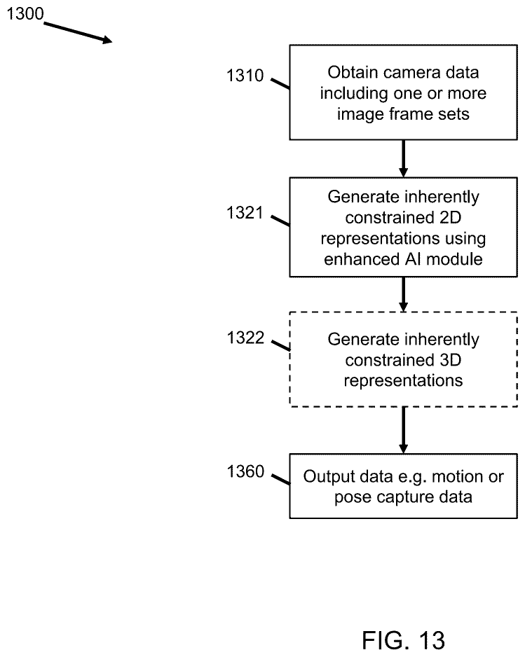

Notably, in embodiments, the enhanced AI module may include a new AI model (or new ML system) or may be an initial AI model (or an initial ML system), such as an (i.e., non-enhanced) AI model (e.g., as used in step 1020 of FIG. 10, step 1110 of FIG. 11, steps 1221 and 1222 of FIG. 12), further trained using the enhanced training data. The enhanced AI module is to be used for motion (or still image) capture, for example in accordance with method 1300 described herein with refence to FIG. 13.

FIG. 13 illustrates a procedure or method 1300 provided according to embodiments of the present invention. The procedure or method can be carried out by part or all of the system of FIG. 1A or FIG. 2, for example, implemented using a computing apparatus, such as an electronic device describe elsewhere herein with reference to FIG. 14, in association with appropriate video cameras or input interfaces and output interfaces. Embodiments of the present invention provide for the entire method 1300 or a portion thereof, particularly the portion pertaining to the generating of the inherently constrained representations using camera data that includes one or more image frame sets.

The method 1300 includes step 1310 of obtaining camera data that includes one or more image frame sets. The camera data may be obtained via at least one camera.

In some embodiments, in the method of using the enhanced AI module for motion or still image capture, or a system correspondingly configured, a plurality (i.e., two or more) of sequential image frame sets, that may cooperatively form a video comprising the plurality of sequential image frame sets, may be obtained from a single camera, each image frame set including a single image. Notably, the video may include other one or more image frame sets that may be omitted from the plurality used for motion or still image capture, for example as being unnecessary (e.g., video includes whole subject in at least some image frame sets thereof, but only a portion of the subject, such as the subject's hand, requires its motion, position, orientation and/or pose captured, or the physical subject is outside the camera's field of view in some image frame sets), to limit use of (e.g., computational) resources (e.g., omitting every 10^{th} sequential image frame set in the video may result in sufficiently smooth motion capture of the subject while making available the resources that would have been otherwise consumed in associating with the every 10^{th} sequential image frame set if such were not omitted).

The enhanced AI module, having been trained using the enhanced training data based on enhanced representations obtained from a model of the physical subject that incorporates physical constraints for the physical subject (type) and is parametrized based on initial representations of the physical subject, is advantageously capable of identifying or generating the inherently constrained representations that are inherently constrained, consistent and coherent with respect to the physical subject, or another physical subject of the same type, due to usage of the model in obtaining the enhanced training data for training of the enhanced AI module.

Further with reference to FIG. 13, the method 1300 includes step 1321 of generating inherently constrained 2D representations. These inherently constrained 2D representations differ from the initial and enhanced representations generated ultimately for obtaining the enhanced training data as described throughout herein, and are not intended for use in generating further training data, although and without limitation that may be the case in some instances, for example where further training of the enhanced AI module may be advantageous, for example, to further improve accuracy and consistency of generation of inherently constrained 2D representations and resulting motion or still image capture data and output, or to train to generate the inherently constrained representations and motion or still image capture data for a new one or more subject type.

Where at least some of the inherently constrained 2D representations are inherently constrained 2D salient point representations, such generated inherently constrained 2D salient point representations of the generating step 1321 may include respective 2D coordinates and may include respective distances, such as respective distances from the inherently constrained salient point representations to the camera plane or a reference point, such a center of the physical subject. These inherently constrained 2D representations may be used directly to generate motion or still image capture output, or may be used to generate inherently constrained 3D representations at step 1322, that may include generating a 3D point cloud of inherently constrained 3D salient point representations, for example. The method 1300 includes step 1360 of outputting data, which may be motion or still image capture data.

In embodiments, the trained enhanced AI module operates to receive camera data that includes one or more 2D image frame sets and to at least identify inherently constrained representations in the one or more 2D image frame sets. The trained enhanced AI module is capable of such identifying without generating initial representations and subsequent generating of the enhanced representations, as discussed elsewhere herein with reference to generating or obtaining the enhanced training data for training the enhanced AI module. The trained enhanced AI module may also process the identified inherently constrained representations or data indicative thereof, to output the motion capture data.

FIG. 14 shows a schematic diagram of an electronic device 1400 that may perform any or all of the operations of the above methods and features explicitly or implicitly described herein, according to different embodiments of the present disclosure. For example, a computer equipped with network function may be configured as electronic device 1400. The electronic device 1400 may be used to implement any one or more of the methods and systems described herein.

For example, the electronic device 1400 may be used to implement receiving and/or obtaining image frame sets, generating and/or receiving initial 2D representations, generating initial 3D representations, generating the (e.g., articulated) model, generating enhanced 3D representations, backprojecting of enhanced 3D representations to obtain enhanced 2D representations, obtaining or generating enhanced training data using enhanced (3D, 2D, or both) representations, training an enhanced AI module using the enhanced training data, generating inherently constrained (3D, 2D, or both) representations using enhanced AI module, outputting motion or still image capture data based on inherently constrained (3D, 2D, or both) representations, further processing of the motion or still image capture data, or a combination thereof. One or more instances of the electronic device 1400 may be provided, each instance implementing respective one or more of the aforementioned methods or steps.

In another example, the electronic device 1400 may be used to implement a system that includes an input module, a representation generation module, a representation generation/(enhanced) AI module, a model-based module, an enhanced training data generation module, an AI training module, an enhanced AI module, an output module, or a combination thereof, each configured correspondingly to perform functions and steps as described herein. One or more instances of the electronic device 1400 may be provided, each instance implementing respective system that includes one or more of the aforementioned modules.

As shown, the electronic device 1400 may include at least one processor 1460, such as a Central Processing Unit (CPU) or specialized processors such as a Graphics Processing Unit (GPU), a Neural Processing Unit (NPU) or other such processor unit, memory 1465, network interface 1475, and a bi-directional bus 1480 to communicatively couple the components of electronic device 1400. The at least one processor 1460 may be operatively coupled to a caching server. Electronic device 1400 may also optionally include non-transitory mass storage 1470, an I/O interface 1485, and a transceiver 1490. According to certain embodiments, any or all of the depicted elements may be utilized, or only a subset of the elements. Further, the electronic device 1400 may contain multiple instances of certain elements, such as multiple processors, memories, or transceivers. Also, elements of the hardware device may be directly coupled to other elements without the bi-directional bus 1480. Additionally or alternatively to a processor and memory, other electronics, such as integrated circuits, may be employed for performing the required logical operations.

The memory 1465 may include any type of tangible, non-transitory memory such as static random access memory (SRAM), dynamic random access memory (DRAM), synchronous DRAM (SDRAM), read-only memory (ROM), any combination of such, or the like. The memory 1465 in communication with the at least one processor 1460 may have stored thereon a set of counters or slots for such set of counters or both. The mass storage element 1470 may include any type of tangible, non-transitory storage device, such as a solid state drive, hard disk drive, a magnetic disk drive, an optical disk drive, USB drive, or any computer program product configured to store data and machine executable program code. According to certain embodiments, the memory 1465 or mass storage 1470 may have recorded thereon statements and instructions executable by the at least one processor 1460 for performing any of the aforementioned method operations described above.

Network interface 1475 may include at least one of a wired network interface and a wireless network interface. The network interface 1475 may include a wired network interface to connect to a communication network 1477 and may also include a radio access network interface 1476 for connecting to the communication network or other network elements over a radio link. The network interface 1475 enables the electronic device 1400 to communicate with remote entities (e.g., one or more camera providing the image frame sets, other sensors that may be used in calibration of multiple cameras, a third party providing the image frame sets, a third party providing the enhanced training data, a third party providing data indicative or representative of salient points, etc.) such as those connected to the communication network 1477.

Although embodiments are generally described herein with respect to motion and video input which generally includes a time series of images, it will be readily understood that the present invention is also applicable to still images which pertain to a single pose at an instant in time rather than motion over time.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A computing apparatus for supporting video-based motion or still image capture, the apparatus comprising one or more processing modules configured to:
receive one or more initial representations of a physical subject, the one or more initial representations provided based on camera data including one or more camera image frame sets;
provide, based on the one or more initial representations of the physical subject in combination with physical constraints specified for the physical subject, one or more enhanced representations of the physical subject, each of the one or more enhanced representations of the physical subject being constrained according to a model of the physical subject, the model incorporating or being configured according to the physical constraints; and
provide output data which includes or is based at least in part on the one or more enhanced representations of the physical subject.

2. The apparatus of claim 1, wherein the one or more initial representations of the physical subject include one or more of:
one or more initial representations of salient points for the physical subject;
one or more initial vector representations for the physical subject;
one or more initial representations of a position, orientation, or both, of the physical subject in the one or more training camera image frame sets; and
one or more initial pose representations of a pose of the physical subject in the one or more image frame sets,
the one or more initial representations of the position, orientation, or both, and the one or more initial pose representations being unconstrained and generated using one or more of:
the one or more initial representations of salient points; and
the one or more initial vector representations.

3. The apparatus of claim 1, wherein the one or more enhanced representations of the physical subject include one or more of:
one or more enhanced representations of salient points for the physical subject;
one or more enhanced vector representations for the physical subject;
one or more enhanced representations of a position, orientation, or both, of the physical subject or the other physical subject in corresponding one or more images of the plurality of images; and
one or more enhanced pose representations of a pose of the physical subject in the one or more camera image frame sets.

4. The apparatus of claim 1, wherein the one or more camera image frame sets includes multiple camera image frame sets, each of the multiple camera image frame sets includes multiple image frames, and each of the image frames of a same one of the image frame sets is indicative of a real or virtual camera image of the physical subject, at a same time or nominally the same time, and from a different respective angle.

5. The apparatus of claim 1, the apparatus further comprising another processing module configured to provide the one or more initial representations of the physical subject.

6. The apparatus of claim 1, wherein the model is an articulated model, and wherein the physical constraints include:
articulation constraints indicative of limitations to positions, orientations, or both, of the physical subject, according to the articulated model for the physical subject, in each of the one or more camera image frame sets taken individually or in combination.

7. The apparatus of claim 1, wherein:
the one or more camera image frame sets includes multiple camera image frame sets, each of the multiple camera image frame sets representing a different respective instance or nominal instance in time; and
the physical constraints include one or more of:
consistency constraints indicative that one or more characteristics of the physical subject are consistent across all of the multiple image frame sets; and
kinematic constraints, dynamic constraints, or a combination thereof, indicating limitations to changes in position, orientation, pose, or a combination thereof, of the physical subject, as indicated by differences between different ones of the multiple camera image frame sets.

8. The apparatus of claim 1, wherein the model is an articulated model, and wherein the one or more processing modules are configured to define parameters of the articulated model of the physical subject based at least in part on the one or more initial representations of the physical subject, the articulated model including two or more rigid bodies interconnected with one another at one or more flexible joints movable within a limited or unlimited range, wherein the parameters include one or more of: sizes, locations and orientations of the two or more rigid bodies.

9. The apparatus of claim 1, wherein the one or more camera image frame sets include two or more camera image frame sets, and wherein the physical constraints include that sizes of one or more constituent rigid bodies of the model are unchanging over all of the two or more camera image frame sets, and wherein locations and orientations of the one or more constituent rigid bodies are subject to variation between different ones of the two or more camera image frame sets.

10. The apparatus of claim 8, wherein the articulated model is a skeleton model representative of a human or an animal, or wherein the articulated model is representative of a non-living object.

11. The apparatus of claim 1, wherein the one or more initial representations of the physical subject include one or more initial representations of salient points for the physical subject, and wherein the salient points have an anatomical meaning for the physical subject.

12. The apparatus of claim 1, wherein:
the one or more initial representations of the physical subject includes one or more initial representations of vectors or salient points for the physical subject, each of the one or more initial representations of vectors or salient points including a respective first spatial coordinate and a respective first label, the first spatial coordinate indicating an estimated location, orientation, or both, of a part of the physical subject, the part corresponding to the first label;
the one or more enhanced representations of the physical subject includes one or more enhanced representations of vectors or salient points for the physical subject, each of the one or more enhanced representations of vectors or salient points including a respective second spatial coordinate and a respective second label, the second spatial coordinate indicating a location, orientation, or both, of the part or another part of the physical subject, the location, orientation, or both being constrained according to the model of the physical subject, the part or the other part corresponding to the second label;
an initial representation of a salient point of the one or more initial representations of salient points and an enhanced representation of a salient point of the one or more enhanced representations of salient points are representative of a same salient point for the physical subject;
the first label of the initial representation of the same salient point matches the second label of the enhanced representation of the same salient point; and
the second spatial coordinate of the enhanced representation of the same salient point represents a version of the first spatial coordinate of the initial representation of the same salient point which is constrained according to the model.

13. The apparatus of claim 12, wherein each of the first spatial coordinate and the second spatial coordinate are three-dimensional spatial coordinates.

14. The apparatus of claim 1, further comprising an input module configured to obtain the one or more camera image frame sets.

15. The apparatus of claim 14, wherein the input module includes two or more synchronized or nominally synchronized video cameras configured to provide the one or more camera image frame sets or video feeds indicative of the one or more camera image frame sets.

16. The apparatus of claim 1, wherein the apparatus is configured to provide an enhanced training data for training of an enhanced artificial intelligence (AI) module to output inherently constrained motion or still image capture data, the enhanced training data comprising the one or more enhanced representations of the physical subject.

17. A method for supporting video-based motion or still image capture, the method comprising, using a computer:
receiving one or more initial representations of a physical subject, the one or more initial representations provided based on camera data including one or more camera image frame sets;
providing, based on the one or more initial representations of the physical subject in combination with physical constraints specified for the physical subject, one or more enhanced representations of the physical subject, each of the one or more enhanced representations of the physical subject being constrained according to a model of the physical subject, the model incorporating or being configured according to the physical constraints; and
providing output data which includes or is based at least in part on the one or more enhanced representations of the physical subject.

18. The method of claim 17, wherein the one or more initial representations of the physical subject include one or more of:
one or more initial representations of salient points for the physical subject;
one or more initial vector representations for the physical subject;
one or more initial representations of a position, orientation, or both, of the physical subject in the one or more training camera image frame sets; and
one or more initial pose representations of a pose of the physical subject in the one or more image frame sets,
the one or more initial representations of position, orientation, or both, and the one or more initial pose representations being unconstrained and generated using one or more of:
the one or more initial representations of salient points; and
the one or more initial vector representations.

19. The method of claim 17, wherein the one or more enhanced representations of the physical subject include one or more of:
one or more enhanced representations of salient points for the physical subject;
one or more enhanced vector representations for the physical subject;
one or more enhanced representations of a position, orientation, or both, of the physical subject or the other physical subject in corresponding one or more images of the plurality of images; and
one or more enhanced pose representations of a pose of the physical subject in the one or more camera image frame sets.

20. The method of claim 17, wherein:
the one or more camera image frame sets includes multiple camera image frame sets, each of the multiple camera image frame sets representing a different respective instance or nominal instance in time; and
the physical constraints include one or more of:
consistency constraints indicative that one or more characteristics of the physical subject are consistent across all of the multiple image frame sets; and
kinematic constraints, dynamic constraints, or a combination thereof, indicating limitations to changes in position, orientation, pose, or a combination thereof, of the physical subject, as indicated by differences between different ones of the multiple camera image frame sets.

21. The method of claim 17, further comprising obtaining the one or more initial representations of the physical subject.

22. The method of claim 17, wherein the model is an articulated model, and wherein the physical constraints include:
articulation constraints indicative of limitations to positions, orientations, or both, of the physical subject, according to the articulated model for the physical subject, in each of the one or more camera image frame sets taken individually or in combination.

23. The method of claim 17, wherein the model is an articulated model, the method further comprising:
defining parameters of the articulated model of the physical subject based at least in part on the one or more initial representations of the physical subject, the articulated model including two or more rigid bodies interconnected with one another at one or more flexible joints movable within a limited or unlimited range, wherein the parameters include one or more of: sizes, locations and orientations of the two or more rigid bodies.

24. The method of claim 17, further comprising providing an enhanced training data for training of an enhanced artificial intelligence (AI) module to output inherently constrained motion or still image capture data, the enhanced training data comprising the one or more enhanced representations of the physical subject.

25. A non-transitory computer-readable media containing a program element executable by a computing system to perform a method for supporting video-based motion or still image capture, the program element comprising:
a first program code that when executed by the computing system, configures the computing system to:
receive one or more initial representations of a physical subject, the one or more initial representations provided based on camera data including one or more camera image frame sets;
a second program code that when executed by the computing system, configures the computing system to:
provide, based on the one or more initial representations of the physical subject in combination with physical constraints specified for the physical subject, one or more enhanced representations of the physical subject, each of the one or more enhanced representations of the physical subject being constrained according to a model of the physical subject, the model incorporating or being configured according to the physical constraints; and
a third program code that when executed by the computing system, configures the computing system to:
provide output data which includes or is based at least in part on the one or more enhanced representations of the physical subject.
